(19) United States
(12) Patent Application Publication
(10) Pub. No.: US 2014/0087685 A1
(43) Pub. Date: Mar. 27, 2014

(54) More efficient display and control for wearable sports instrumentation

(71) Applicants: Cheryl Kellond, Manhattan Beach, CA (US); Sylvia L. Marino, Mill Valley, CA (US)

(72) Inventors: Cheryl Kellond, Manhattan Beach, CA (US); Sylvia L. Marino, Mill Valley, CA (US)

(21) Appl. No.: 13/573,532

(22) Filed: Sep. 21, 2012

(51) Int. Cl. G08B 21/02; G06F 3/041; H04W 4/22; G06F 3/01

(52) U.S. Cl. 455/404.2; 345/156; 345/173; 340/573.1

(57) ABSTRACT

Technology for supporting personal sports performance moves from laboratory to field use only as and if instrumentation is designed both to meet its specific function(s) and to least hinder the athlete's performance. Even a standard wristwatch degrades an athlete's optimal motions when an athlete reads it while training or competing. This invention details a casing and strap (more specifically said casing's and strap's interacting shapes' and attachments' form, lie, and linkage), and controls, for a display for monitoring/sensory and/or feedback/reporting sports instrumentation, which meet both the sports instrumentation's and athlete's functional needs, as the casing and strap place the display and control diagonally across yet flush with the athlete's forearm.

### CROSS-REFERENCES

This patent application is related to the copending application filed on the same date with the identical named inventors titled “Bi-Directionally Operable, Toolessly Changeable, Strap for a Wearable Display” with that copending application's specification and drawings specifically incorporated herein by reference, but not admitted to be prior art with respect to the present invention.

### GOVERNMENT RIGHTS

None

### BACKGROUND OF THE INVENTION

1.A. Field of the Invention

This invention is in the field of sports equipment; more specifically, the field of sports instrumentation, that is advanced (and chiefly electronic) devices and systems incorporating any of a set of sensory, reporting, recording, tracking, feedback, or other functions, which an athlete may wear or carry while actively engaging in his or her chosen athletic endeavor.

An athlete wears or carries sports instrumentation while engaging in practice, training, conditioning or a competition in order to measure, track, and over time improve her performance and/or condition. The athlete uses the sports instrumentation to both monitor internal or external conditions and to monitor and provide feedback for her performance. Sports equipment is distinctly not sports instrumentation; the former is a necessary part of the sport (e.g. clubs, rackets, shot-puts, relay batons) while the latter is not (and often is not allowed to be worn or carried by the athlete during professional competitions). Thus ‘sporting equipment’ is used to play the game or engage in the sport, but ‘sports instrumentation’ is used, or chiefly intended, to aid or sustain the wearing athlete's attained level of performance.

Sports instrumentation also is distinctly different (though sometimes derived) from medical instrumentation. Medical instrumentation—particularly devices and systems for sophisticated monitoring, and electronic sensing and reporting, of individuals' internal biometrics—is chiefly used within, and designed for, environments such as doctors' offices, clinics, and hospitals where the conditions and activities of the patient are controlled and relatively passive. With recent manufacturing advances including miniaturization, particularly with chip-wise-embedment, moving laboratory-level equipment into the field for real-time, in-action monitoring, recording, and feedback of an athlete's actual performance is becoming now more realistically attainable and affordable at the individual (as opposed to national team or paid-professional athlete) level. Shifting from medical instrumentation to sports instrumentation requires considerable redesign; a key constraint for the latter which is usually absent from the former requires that the sports instrumentation shift from being transportable (or ‘luggable’), to not merely being portable, but minimally interfering with the athlete's active motions. Also, sports instrumentation generally must be much hardier, particularly with regard to enduring the shocks of active, even energetic, motion.

One specific class of sports instrumentation has an extensive history: timepieces. These have been in active use for scores of years (even centuries if you include naval officers bearing turnip-sized watches). As have their more complicated cousins, i.e. chronometers, stopwatches, and multi-function combinations thereof—but only now are they generally moving from the standing hands of trainers and coaches, to the moving bodies of the individual athletes. A significant problem has been the ‘stickiness’ of pre-existing concepts and past realizations; this is simply the inertia of past designs (for past concerns), which serve as starting assumptions of what ‘must be’ or ‘is best’. Most people simply used and use what was and is available without considering their real need. The presumption and preference across people and history has been, largely, that people adapt to devices, rather than adapting devices to individuals' needs and concerns. Once a ‘good enough’ solution has been found, little or no further advance was made. Until someone re-thought about the problem with an original viewpoint.

1.B. Description of the Related Art

Before the First World War a “watch” almost universally meant a pocket watch—round or oval in shape, more or less thick, sized to fit within a user's hand when being consulted, slipped into a pocket or dangling from a watch-chain when only being carried. To change this took the hazards of the trenches—and the need to coordinate without communication movements of both artillery barrages and infantry units. The new need created a new invention: the wrist-watch.
“Artillery and infantry officers depended on their watches as battles became more complicated and coordinated attacks became necessary. Wristwatches were found to be needed in the air as much as on the ground: military pilots found them more convenient than pocket watches for the same reasons as Santos-Dumont had.” (See http://en.wikipedia.org/wiki/History_of_timekeeping_devices.)

Wristwatches—which could be carried on one forearm and used without requiring the other hand to move the crystal's protective cover—became the new, “advanced”, standard portable timepieces. An officer, NCO, or even private could crook his arm (usually the left, as most men were right-handed) so that his ulna and radius were perpendicular to and directly in front of, perhaps lower than, his face. Thus a soldier could read a wristwatch while flattened on his stomach without having to remove his right hand from his weapon or raise one button's width higher.
“Real gentlemen, who carried pocket watches, were actually quoted as saying they would “sooner wear a skirt as wear a wristwatch”.^{[citation needed]} This all changed in World War I when soldiers on the battlefield found using a pocket watch to be impractical, so they attached the pocket watch to their wrist by a cupped leather strap.” (http://en.wikipedia.org/wiki/Wristwatch; hyperlinks removed.)

In the Second World War, two more demanding functions were required of, and incorporated into, higher-end and more expensive wristwatches. Aviators needed more complex and more accurate timepieces to track fuel consumption and to successfully navigate over clouds or seas when landmarks were not viewable. Free (non-tethered) divers needed underwater timepieces to measure with care such things as air tank usage and time-at-depth (for nitrogen blood gas levels). Chronometric (meeting a defined standard of precision over ranged times and temperatures), chronographic (incorporating a stopwatch), and waterproof functionalities were each, and all, incorporated into wristwatches—as always, initially into the higher-price commercial pieces. An excellent display of the range of classic wristwatches can be found at: http://en.wikipedia.org/wiki/Gallet_%26_Co.#Vintage_Wrist_Watch_Gallery/.

All of those wristwatches share the same design limitations—limitations common, and nearly universal, in the marketplace today. See, e.g. the multiple-pages of ‘sports watches’ commercially advertised at Zappos.com:
http://www.zappos.com/watches-sports˜1?gclid=CJWXob6sv64CFUcHRQodNkbOFA#!/sports-watches-watches/CLHXAeICAQE.zso?t=sports+watches&p=0.

Wristwatches have a casing and a strap which, if laid flat, extend in a straight-line, and which, when bent, form a simple circle with a single axis of curvature. Watch, i.e. casing and strap, are worn at and perpendicular to the user's wrist. (Hence, the name. In some things English is pragmatic.) The overwhelming majority of wristwatches orient their display parallel to the user's radius and ulnar bones, and connect to the strap at the top and bottom of the casing. To place the display where it is most easily read (which is both in front of the face and parallel to the eyes) the user will both fully bend his elbow and rotate his forearm (each a rotation of 90°). For most American adults these motions are a single, combined, even reflexive action; only specialists in physical motion—or those dealing with pre-schoolers learning to ‘tell time with Mickey’—are conscious of, or apprehend and appreciate, the embedded complexity of this long-since-mastered effort.

Out of 646 sports wristwatches found at the above-referenced site, only 3/10^{th}s of 1% (two; each a ‘Nike Sportband’, p. 3 of the above-referenced site) used the second, and thus alternate, alternative orientation; these set the display perpendicular to the bones of the forearm (a 90° rotation from the norm). To read these requires holding the forearm pointing directly ahead and rotating it 90° ‘inwards’, which places this display ahead of and parallel to the eyes—though the display remains offset; so the user must turn his head or look sideways (or both), unless the elbow is tucked against the body or forearm is angled in front of the torso.

Further specific prior art identified during preparation of this application are discussed and differentiated in the Detailed Description, below.

1. C. Contextual Concerns.

Athletic competition has become increasingly demanding. Athletes aspire to greater and greater capabilities. Health-conscious individuals seek like improvement. Consequently, details which in earlier decades were heeded only (if at all) by Olympian aspirants and professional coaches (think of Harold Abrahams, played by Ben Cross, and Sam Mussabini, played by Ian Holm, in Chariots of Fire), are now a concern to a great many more athletes—professional or amateur, male and female. Optimal bodily motions are carefully searched for. Friction with the surrounding medium (fluid or air), and other sources of ‘drag’ such as internal tensions, are increasingly of interest. Subtle interferences with each particular athlete's optimal motion and/or balance are no longer ignored or overlooked. When milliseconds count, micromotions matter.

Furthermore, both athletes and individuals who are just exercising for their health now concern themselves over more and more exercise-related physical factors than pacing and timekeeping—such as point-in-time metabolic states, contextual responses, or constraints experienced or encountered during their active effort. Blood pressures (systolic and diastolic), pulse rate, blood oxygenation, and other ‘medical’ details—precise geolocation, vector-and-distance, even max-shock accelerometric, and other readings—these and other measurements have and will become viewed by athletes as important to monitor, record, and track.

An athlete can use direct and contemporaneous feedback to monitor and improve her sport activity only through using sports instrumentation which takes personal readings in the present and ‘in-activity’ context. By incorporating such present-in-time readings with past records, she can use analytical/computational/comparative tools to guide her current and subsequent efforts and improve, or sustain, longer-term trends. Informed, current, and above all individual feedback most effectively supports athletes in both improving their performance and attaining goals—not just contest victories or awards, but also personal or health-related goals.

Sensors become combinatorially more useful when individual readings can be combined—whether the combination is over time, across multiple individuals, or across other domains of measurement. For example, pulse or blood pressure readings are individually less useful than a point-in-time combination of blood pressure and pulse. To effect any combination requires recording and analytic (computational/comparative) mechanisms; yet these need only communicate, not be physically co-extant, with the sensor(s) and display(s). But such recording and analytic mechanisms will require extra mass, and extra mass will distort the user's balance, and thus their motion and performance, proportionately to its location distal from the user's center of mass.

Sports instrumentation has focused on making instruments more capable, durable, versatile, and accurate. Yet what attention has been paid to making such instruments more usable in the field and by the athlete during her activity? What if thought were given to fitting sports instrumentation to an athlete's body and motions, instead of forcing her to adapt her motions to the sports instrumentation? Consideration of ‘fit’ which puts the user, as opposed to the device, at the top of the design priority, might well pose new, challenging, and different questions—as the inventors asked the right questions.

### SUMMARY OF THE INVENTION

The present embodiment of the invention is a casing and strap whose shape and inter-attachment conform with an athlete's forearm—not her wrist—at a diagonal crossing her ulna and radius, so as to place a display and control for the sports instrumentation which is perpendicular to her forward viewing angle with a minimal distortion of her motion and balance while she is in active motion. The location, placement, and interaction of casing, strap, display, control, and the athlete, and potential separation of casing and display from the sports instrumentation, and further any recording/analytic elements of a system, enable use of the sports instrumentation during her physical activity while minimizing the hindrance to her optimal athletic breathing, balance, and motions (including that of her arms, torso, diaphragm, hips, and legs) from all elements.

Furthermore, the invention as described herein reduces frictional drag. The casing has a low profile, minimal surface, and smoothly-curved corners and edges. Its bottom (the skin-side surface) curves in two planes (thus, three dimensions) to match the diagonal of the conic curvature of the forearm. Furthermore, slightly inward of each corner on the bottom is a small, curved, outwardly (and thus downwardly) protruding nub that all assist the strap in anchoring the casing's display at the location and orientation desired by the user. The casing and strap thus grip the forearm snugly while placing the display and control proximally from (or ‘above’) the athlete's wrist, thereby reducing the leverage effect of the mass of the casing (and contents) through a simple shortening of the ‘lever’, i.e. the forearm.

If this casing and strap, and the display and operating control of the sports instrumentation, are combined with a system further comprising any of the set of recording/analytic/comparative/computational element(s) through one or more communications linkages, then the bulk of sensing, recording, communication, and computational equipment can separated from that of the display and control; no longer need all be in a monolithic or unitary housing. Thus, this casing and strap make it possible to separate the mass and location of those portions of any sports instrumentation which are necessary to effect the display, and those which are necessary to effect sensing, recording, analysis, and communication concerning the athlete's internal condition(s), experienced external condition(s), previous and/or projected (goal) performance. This in turn enables non-display, non-control elements to be located elsewhere, whether that be more central to the athlete's torso or even (depending on the nature of the communications linkages) off the athlete's body altogether, thereby reducing, minimizing, or even eliminating distortions due to maintaining such elements' mass distal to the athlete's center of mass and balance while the athlete is actively exercising. No longer need a multifunction or ‘all in one’ sports instrument be also a ‘wrist weight exercise enhancer’—and drag.

### DESCRIPTION OF THE DRAWINGS

FIG. 1 shows a more efficient display and control for wearable sports instrumentation in use. The display [1] and a primary control [3] are contained in a contoured casing [5] and held by a strap [7] to and diagonally across the athlete's forearm [2], and so are thereby viewable and useable while running without the athlete having to turn or hold head [4] or body [6], and with the athlete making no or minimal adjustment to her balance and optimal dynamic motion.

FIG. 2 PRIOR ART This shows the prior art for wearable sports instrumentation display and control (in this case, a watch [10]). To read the watch [10] which is at the user's wrist [8] and perpendicular to his forearm [2], the user must lift, turn inward, and rotate his forearm [2], and lower his head [4].

FIG. 3 PRIOR ART This shows the prior art for wearable sports instrumentation display and control (again, in this case, a watch [10]) in use. To read the watch [10] the user's forearm [2] and head [4] must be rotated and tilted to put the line of the viewer's eyes and the plane of the watch's display into common alignment; and the body [6] must tense against the imbalance this creates, thus interfering with both his running balance and his dynamic motion, and impairing his performance.

FIG. 4 shows the more efficient display and control for wearable sports instrumentation in another use. The placement of the casing [5] naturally brings the display [1] within the swimmer's view during her optimal, dynamic, swimming motion, thereby allowing her to check the remaining time for a record performance while maintaining both her stroke power and breathing cycle, as she need not change, check nor alter any motion of her forearm [2], head [4], or body [6].

FIG. 5 shows the display [1] and a primary control [3] are placed in sequence along the asymmetric and lengthened dimension of the casing [5]. At least one pair of contoured attachment loops [11, 13] are incorporated into the casing [5] on opposite sides, and closest towards opposite ends of the lengthened dimension, from each other. At least one strap [15] is passed through and held against a first member of the pair of contoured attachment loops [11], around the forearm [2], passed through and around a second member of the pair of contoured attachment loops [13], and then bound to itself (not shown), such that the casing [5] and strap [15] will hold the display [1] and a primary control [3] on and to a diagonal line across the forearm [2] above the flexion line of the wrist [8].

FIG. 6 shows an alternative, ‘mirror’ layout where the orientation and sequence of the display [1] and a primary control [3], of the at least one pair of contoured attachment loops [11, 13], and of the strap [15], are all shifted to accommodate a right forearm [2], still above the flexion line of the wrist [8]. This same orientation, were the strap [15] and casing [5] to be placed on a left forearm, would place the display [1] and a primary control [3] in a vertical orientation for the user (so, similarly, would placing the orientation shown in FIG. 5 on a right forearm).

FIG. 7 shows the top face of the casing [5] with its asymmetric long and short axes respectively forming its sides and ends, with each side on the long axis [10] and each end on the short axis [12]. Also seen is the sequential orientation of the display [1] and a primary control [3] along the long axis, and the rounded and curved edges and corners [14, 16, 18, 20]. On the bottom, right-hand side is the first member of the pair of contoured attachment loops [11] and offset from it, on the opposite side and towards the opposite end (thus on the top, left-hand side), is the second member of the pair of contoured attachment loops [13], whose joinings (inward and outward) with the casing's sides are also curved.

FIG. 8 shows the bottom surface [21] of the casing [5]. The bottom surface [21] has an axis of curvature [23] that is diagonal to the long axis of the casing [10]; this curvature is continued along the bottom surface of each contoured attachment loop [11, 13]. This creates a three-dimensional and generally concave curvature which matches that of the portion of the forearm (not shown) across which the casing [5] will diagonally lie. The shape of the bottom surface angles the top surface to align the long axis of the display across the user's central, forward, view line. At each corner of the bottom surface [21] is a convex gripping nub [25] that protrudes from the generally concave curvature.

FIG. 9 shows (from the bottom and corner) an expanded view of a single corner of the casing [5], showing how the corner between the long and short axes [27] is curved rather than sharp. Also shown more clearly is the convex gripping nub [25] that protrudes from the generally concave curvature of the bottom surface [21].

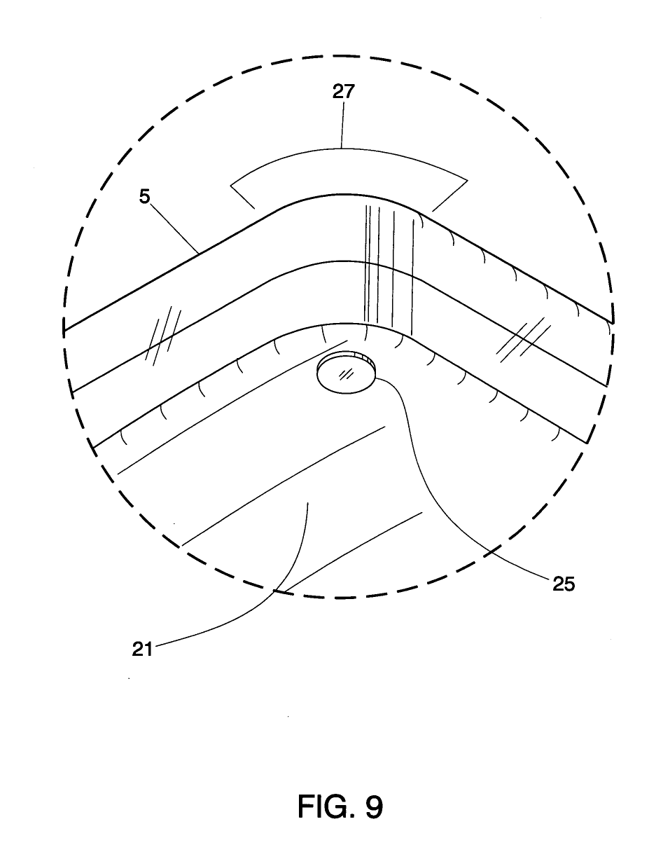

FIG. 10 shows a view of one of the long sides of the asymmetrical casing. On the right-hand side of the drawing is one of the contoured attachment loops [13] diagonally offset from the other member of its pair which are placed on the respectively opposite ends of the long axis from each other and on opposite sides, with each contoured attachment loop shaped to both be lower than the maximal height of the casing and to follow the curves of the bottom surface [21]. All of the casing's corners and edges [29] are curved to minimize turbulence. Just to the left of the end of the contoured attachment loop [11] on the left-hand side of the drawing can be that corner's protruding gripping nub [25]. This view makes evident the fact that the height of the casing [5], leaving out the portions forming the curvature of the bottom surface [21], is proportionately much less than its length, and also that the contoured attachment loop's thickness [31] is kept to half the height of the side of the casing [5] at its thinnest part.

FIG. 11 shows an expanded view of the casing [5] where the long side joins with the short end and the top face with the sides and end, showing how each corner [29] is curved from the top to the side (as well as from the side to the end; see FIG. 13). Also more clearly visible is the contour of that side's attachment loop and its curving meld with and into the side of the casing.

FIG. 12 shows an end view of the casing [5]; on the left long side, as a first member of a pair, is one contoured attachment loop [11], and on the right long side, as a second member of a pair, is a another contoured attachment loop [13]. The curvature of the bottom surface [21] is visible, as are, on its right side (from this point of view) at opposite ends, each protruding gripping nub [25] at the respective corners.

FIG. 13 shows an expanded view of the corner of the casing [5] as seen from the short end, showing the other curvature (side to end) of the corner [29]; and also the curving descent, to match and extend the bottom surface (not shown), of the contoured attachment loop [11] on that long side.

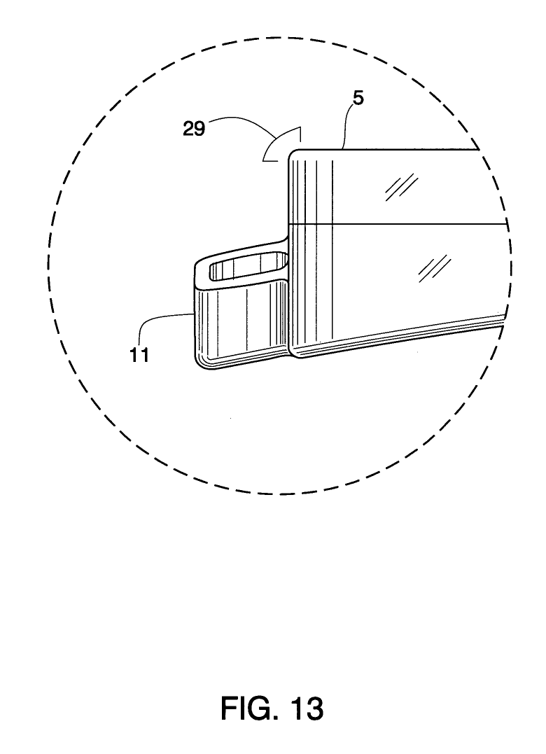

FIG. 14 shows the display [3] in a secondary mode; in this example showing the heart rate (indicated by the ‘heart’ icon), its value (with ‘beats per minute’ scalar key not shown), its relative change over the past five minutes as a line graph (scalars not shown), and an indication of the most recent change (with an upward arrow). Also not shown on the display are secondary ‘touch-control’ icons specific to or used in this secondary mode of the display.

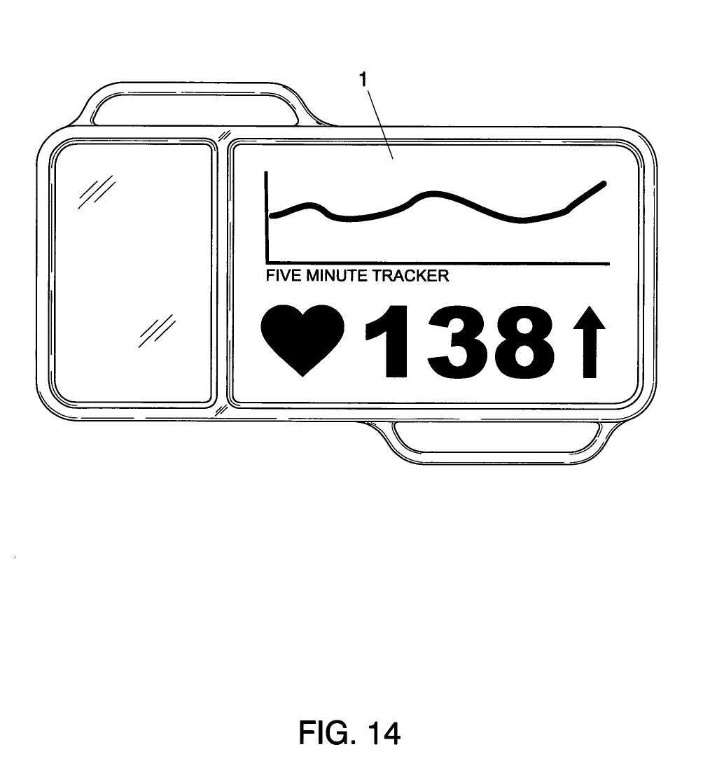

FIG. 15 shows the display [3] in an alternative secondary mode; in this example showing the heart rate (indicated by the ‘heart’ icon), its value (with ‘beats per minute’ indicated by the acronym ‘BPM’), and the most recent high and low systolic and diastolic readings. Again, not shown on the display are secondary ‘touch-control’ icons specific to or used in this alternative secondary mode of the display.

FIG. 16 shows the display [3] in another, different, alternative secondary mode; in this example a local topographic map is shown with the compass heading and ‘N’ for North indicator to orient the view, the present latitude and longitude, and the past trail (in a solid line) taken to the present position (shown with a cross ‘+’). Again, not shown on the display are secondary ‘touch-control’ icons specific to or used in this different, alternative secondary mode of the display.

FIG. 17 shows the display [3] in yet another, different, alternative secondary mode; in this example a feedback on progress towards a goal (length of travel for this session) is shown with both numerical values (including the total ‘10 k’ at the top, and the portion completed and uncompleted, 6.4 and 3.6 respectively) and a fast-read ‘temperature bar gauge’ display underneath the numerical values. Again, not shown on the display are secondary ‘touch-control’ icons specific to or used in this yet another, different, alternative secondary mode of the display.

FIG. 18 shows the display [3] in still yet another, different, alternative secondary mode; in this example the compass heading for the user's current path of travel is shown with both numerical and graphical display values (the latter in an analog image of a compass face with the needle pointing to the position on the circle offset from North which matches the heading). Again, not shown on the display are secondary ‘touch-control’ icons specific to or used in this still yet another, different, alternative secondary mode of the display.

FIG. 19 shows the display [3] in one more different, alternative secondary mode; in this example a local map with both streets and trails is shown. Again, not shown on the display are secondary ‘touch-control’ icons specific to or used in this one more different, alternative secondary mode of the display.

FIG. 20 is a graphical illustration of how the more efficient display and control for wearable sports instrumentation [101], in an alternative embodiment which further comprises a wireless communications link [102], can integrate the display and control's current reading(s) [99] (in this example, heartbeat rate and blood-pressure readings, systolic and diastolic), by sending and receiving communications from a remote computation and record-keeping system [103] thereby effecting comparison between the current readings and any set of prior stored data and immediate, intermediate, short-term or long term goals [105] (in this example, yesterday's average readings, the monthly average readings, and the goal average readings); and display as a consequence any set of recorded or analyzed results [107] communicated back through the wireless communications link [102] to the wearable display and control [101] (in this case, a graphical ‘thermometer gauge’ readout both of how close the current readings are to the goals and which direction of change is desired—the downward arrows).

FIG. 21 is a graphical illustration of a further embodiment whereby the more efficient display and control for wearable sports instrumentation [101], in an alternative embodiment which further comprises a wireless communications link [102], by sending and receiving communications from a remote computation and record-keeping system [103], thereby effecting comparison between the current readings and any set of prior stored data and immediate, intermediate, short-term or long term goals [105], can provide feedback (including perhaps supporting analysis, encouragement, or commentary) to and from any of the set of other individuals such as a coach or health professional [104], a group of supporters or friends [106], as to the user's current performance relative to a goal or pledge [108].

FIG. 22 is a graphical illustration of a further embodiment whereby the more efficient display and control for wearable sports instrumentation [101], in an alternative embodiment which further comprises a wireless communications link [102] and a secondary sports instrumentation sensor [120], by sending and receiving communications from a remote computation and record-keeping system [103], thereby effecting comparison between the current readings and any set of prior stored data and immediate, intermediate, short-term or long term goals [122], can effect feedback (including any of analysis, encouragement, or comments) to improve the current performance [109].

FIG. 23 is a graphical illustration of a further embodiment whereby the more efficient display and control for wearable sports instrumentation [101], in an alternative embodiment which further comprises a wireless communications link [102], by sending and receiving communications from a remote computation and record-keeping system [103], thereby effecting comparison between the current readings and any set of constraints for safety or health [125], can trigger an emergency alert for one of any set of predetermined contingency patterns depending upon a current reading exceeding a constraint, and, as part of that triggered emergency alert, effect an immediate response [110] (in this example, a call to ‘911’ for emergency medical care when safe limits to blood pressure are exceeded).

FIG. 24 is a graphical illustration of a further embodiment whereby the more efficient display and control for wearable sports instrumentation [101], in an alternative embodiment which further comprises a wireless communications link [102], by sending and receiving communications from a remote computation and record-keeping system [103], can intercommunicate discovered and most current information to suggest alternative choice by a second user wearing a like more efficient display and control for wearable sports instrumentation and wireless link—in this example, a warning of a blocked trail from a flooded footbridge [103], not yet visible on the second user's display of her proposed route.

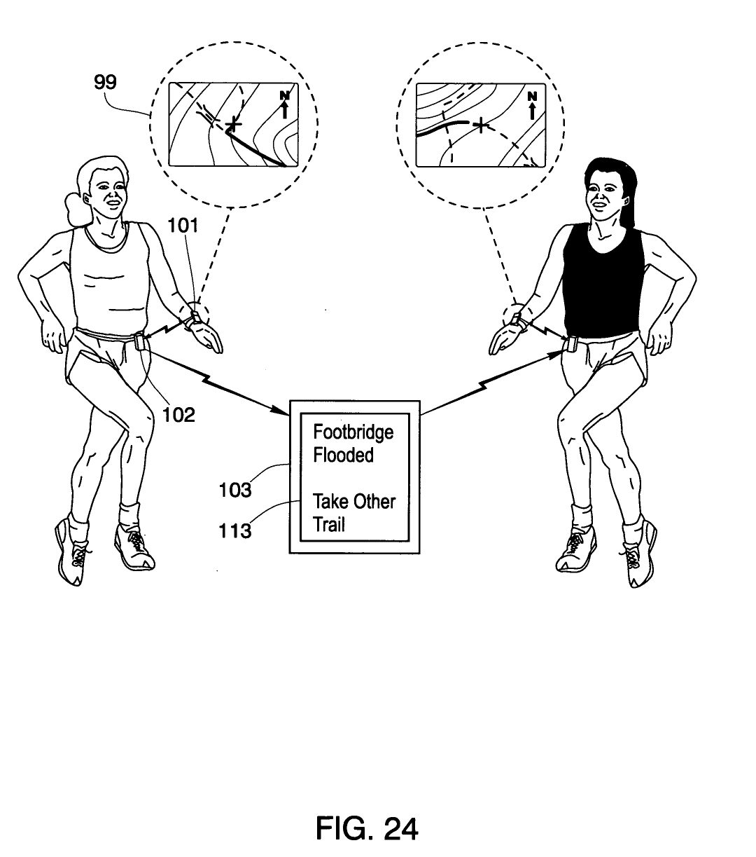

### DETAILED DESCRIPTION

While the invention described herein was originally conceived by and for women, the solution(s) embodied in this invention are also extensible to men, who are most definitely not excluded from the set of users, though fine differentiations in further extensions may address sex-specific constraints, requirements or needs. The inventors' original focus on the needs of women is what enabled them to identify and then solve concerns which male athletes (and more realistically, the mostly-male leadership and engineering management of equipment manufacturers) had neither adequately perceived nor addressed.

Medical instrumentation devices, even those miniaturized and allowing a patient to observe his own state, are designed with concern for the individual's medical, as opposed to athletic, performance. (See, for example, a pulse meter that entangles the user's wrist, hand, forefinger, and thumb at: http://en.wikipedia.org/wiki/Pulse_meter.) They are designed for generally-passive patients and are neither designed nor intended to be worn by an athlete actively engaging in her sport of choice, and generally are designed for use in the laboratory, not in and during an athletic practice or competition.

Several of the words used in this application draw from the medical and anatomical terminology. ‘Proximal’ means ‘towards the torso when following the line of the limb’; ‘distal’ means ‘away from the torso when following the line of the limb’; ‘outer’ means ‘furthest from the torso when crossing the line of the limb’; and ‘inner’ means ‘closest to the torso when crossing the line of the limb’ These directions presume the limb is in a relaxed position at the side of the torso with the back of the hand facing forward.

There are many different potential sports instrumentation devices. Most operate within a series of repeating bouts of athletic activity (performances over multiple sessions and times). With just a watch, an athlete may want to time her current exercise session so she can then later compare and analyze her completion times over given distances during different seasons. Or with a map display she may want to track route-specific, terrain-imposed deviations, so she can then later compare and analyze her average speeds on flat, hilly, urban, and mixed routes. Or she may want to use an advanced mapping system which interacts with external, third-party, satellite signals to locate her position at regular intervals, to measure and evaluate changing vectors to third parties or goal points. Other sports instrumentation devices and systems might include a display for plotting and projecting respectively her completed and pre-planned but as-yet uncompleted route segments; or devices to sense or detect, record, track, and display any number of conditions, whether those conditions are internal to the athlete (pulse rate, blood pressure, blood oxygen level, body temperature, etc.), external in her environment (barometric pressure, humidity, air or water temperature, etc.), or separated in time or by subject, i.e. had been obtained or already retained and/or collated from her earlier, or a competing athlete's present, performance; or any subcombination up to and including all of the above! Yet for any sports instrumentation to be useful to the athlete during her performance, she must have during her performance, access to a display and control which enable her to view the data, which means she must bear (or wear) that display and control—and if the sports instrumentation is measuring her immediate context, internal or external, then it also must be present and with her. Yet need the sports instrumentation be physically co-extant with its display and control?

Sports-related timepieces—particularly those with multiple functions, and those incorporating additional sensory or other functionality, such as ‘GPS-watches’—are large, heavy, bulky, and poorly-oriented and generally not designed for women athletes. The diminishment in performance caused by badly-fitting, large, bulky, massy timepieces (or other sports-instrumentation incorporating both sensor and display) was more readily apparent to the female inventors who had less in the way of both overall body mass and upper body mass and strength, than men do. In a very physical, real, and immediate sense, necessity was indeed, a partial ‘mother’ to this invention.

Additionally the muscular and skeletal attachment and ranges of motion during normal activity—both sports-related and passive standing, or sitting, postures—made problems with the extant and standard orientation of sports-instrumentation displays more problematic for women than for men. At rest or in motion, the upper surface of men's forearms are more readily and more often turned towards the visual field of men's eyes, than is the case with women's forearms and eyes. Moving a forearm such that a display is most easily read while the user is in motion, requires more rotation and flexion of the forearm and elbow for women, than it does for men.

Women experience more of a problem with the design and ‘fit’ of sports instrumentation of every kind on the market, from timepieces to blood pressure readouts to GPS displays. These problems meant that use of existing sports instrumentation required more distortion and effort on the part of women, and thus more often disturbed or hampered their performance in running, swimming, climbing, or other physical activities. This was true with timepieces, or any sports instrumentation which the female athlete would use while engaging in her sport activity (when training, practicing, exercising, or competing; as opposed to, say, a post-activity review such as reading a printout or planning her next round). However much inventive effort may have gone into the creation of any particular device of sports instrumentation, there was little to nothing addressing its fit to the female user's in-activity interest, need, and constraints.

The ‘wearability’ or ‘fit’ of any object which is meant to be carried around and used by a human being has a functional aspect, not merely an ornamental one. This functional aspect is increased when the wearability or fit affects, or may affect, the activity and performance of the wearer. It becomes a limiting or distorting constraint whenever the wearer or user must adapt her optimal physical motion to the needs of the sports instrumentation. The less an athlete has to modify her motion or activity in order to use a sports instrument, the more effort she can devote to improving her performance and the more benefit from any conditioning, and/or training effort, she will receive through using that sports instrumentation. A better fit includes aspects of mass, shape, position, location, and attachment; and these aspects must be combined and considered over the ranges of motion, and conditions of use, female athletes would and will experience.

If an athlete is going to have present any sports instrument, she will want to wear it rather than carry it, to retain full freedom of use of both hands. Yet she will also want it worn such that she can use it with a minimal alteration of the position and motions of her head, arms, legs, and body. For most sports instrumentation, to ‘use’ it is principally to view its display—we are a visually-oriented species and use vision to process far more complex information most effectively, as Edward Tufte has effectively pointed out.

To view any display, it must be in front of our eyes. Human beings have a strong eye-hand linkage in their brains, which probably made the wrist location seem the optimal and natural choice for where to wear a timepiece—or any sports instrumentation with a visual display. Only devices where that location would interfere with their proper functioning (e.g. a pedometer) were not ‘fixed’ to the wrist.

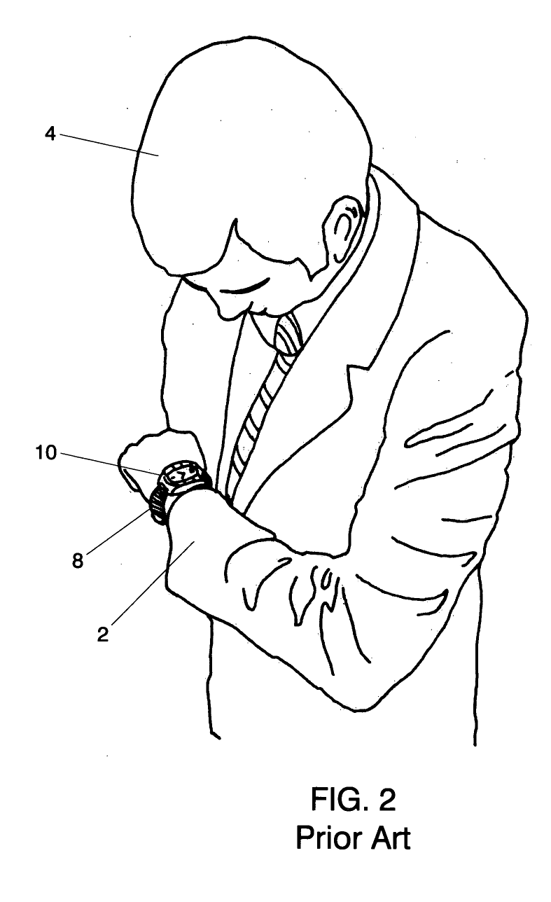

The simplest answer to the problem of wearing, or carrying, sports instrumentation incorporating a display—exemplified by the standard wristwatch—is to combine the two into one device and strap that device around the wrist, placing it just far enough above the flexion plane of the hand to prevent the back of the hand from bumping into the device as the hand flexes (bends) forward or backwards. Then to view the display the user's forearm is lifted, or held, in a position parallel to the ground, his elbow is bent to bring the forearm inwards and perpendicular to the line of vision from his eyes, and his forearm is rotated until its flattest plane (top or bottom) is also parallel to the ground—all that in order to ‘read Mickey’. [FIG. 2]

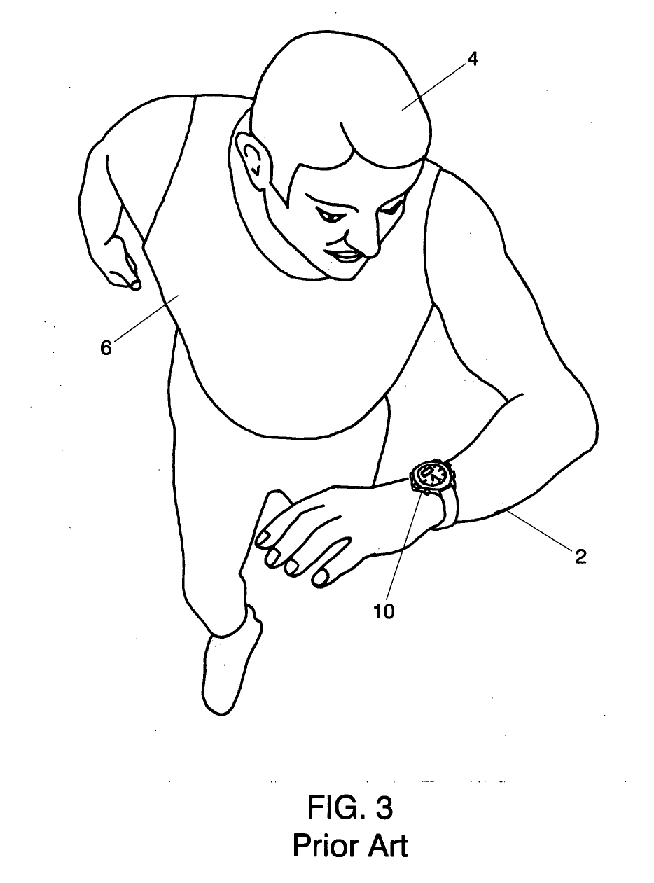

For any user, putting a device's display in front of the eyes either already is or soon becomes an automatic and unconscious motion. One just bends his elbow inwards and rotates the forearm either ‘up’ or ‘down’ to bring the palm-side or back-side of the hand, and thus the display, in line with his vision. This minimizes the motion of the head. To the extent that the user wishes to keep his eyes focused chiefly on the outside environment, he merely adjusts the lift, inward bend, and rotation of his arm to suit [FIG. 3]. By placing the device on the non-dominant hand, this motion interferes less with the continued activity and motion of the dominant hand, and so minimizes the perceived mental effort required to view the display. This leaves the user's dominant hand available to interact with and use any control(s), and thus activate the function(s) and mode(s), of the device. For most adults, such a device seems ‘easy’ and ‘natural’, and using it becomes almost reflexive and unconsciously controlled. Thus using wearable sports instrumentation and putting the display on the wrist, like a watch, seems ‘obvious’ and ‘natural’—and thus optimal for dynamic, i.e. in-performance, interaction. Yet this perception contains two subtly hidden traps.

Gravity works everywhere (that's the first trap). Because the human body is bilaterally symmetrical, if one arm (or a lesser part, such as a forearm) moves ahead, back, in, or out, this change must either be matched by a countering motion by the other and now-unbalanced side, or some sub-set of the user's torso, hip, and leg muscles must tense, in order to resist the changed gravitational vector resulting from the off-center displacement of the moved body part from the user's center of balance. While such activity is nearly always unconscious, it is still present. It is also demonstrable. One need only stand still and relaxed with both hands and arms at one's side, with a minimum of muscular tension in all of your supporting muscles. Next, raise one forearm while bending that elbow inwards, placing the forearm ahead of the torso—where you would place it to look at a watch. Make no other motion and most importantly, do not allow any ‘corrective’ tensioning of any of your muscles of your feet, legs, or back. (This is very difficult to either do or notice, because it requires one to override subconscious and automatic rebalancing efforts that a lifetime of not falling down has drilled into body, nerves, and brain.) You will experience a forward tilt, as your center of balance has moved forward—which would in fact lead you to fall down if you do not either take a step or tense your supporting muscles. This reactive muscle tensioning is subtle, but it constrains your ability to move—though few without considerable experience in coaching athletes or learning to sense their own motion, muscular tensions, and balance (i.e. experienced dancers or martial artists) may be able to spot this effect.

Gravity also works all the time (that's the second trap). Because the human mind must shift between interpreting the body's sensory signals governing athletic endeavor and interpreting the display's abstract signals, and back again, if you are in motion when you read the display, your subconscious must guide your dynamic balancing. The more you must distort your natural motion-in-movement to read the display, the more these motions divert your body's dynamic flow from the optimal path of least effort, and the more compensatory effort is required. (For example, you may slow the arm's motion to ‘pause’ or steady the display, or tense your torso and hips to hold the forearm up and forward.) Such micromotions or slight tensions decrease your available reserves of flexibility and energy for your continuing athletic effort. This effect is also not easily perceived or measured—but in today's athletics, micromotions matter, as milliseconds count.

Changing the location and orientation of the display of the sports instrumentation, though it seems a simple concept, involves consideration of anatomical and physical realities. For over a century there has been one dominant approach—a wrist-centered case-and-strap. The case and display had to avoid protruding distally over the back of the athlete's hand—the distal edge of the case had to avoid crossing the upward flexion line of the wrist, lest a backward-flexed hand bump, or be blocked by, the case. (See, e.g. http://www.genzomedia.com/112010/nook-zub-zayu-ergonomic-futuristic-wristwatch.)

Cases also had predominantly a flat bottom, though some few have a bottom with a single curvature matching the wrist's upper surface's elliptical but mostly-flat curve. (See, e.g. http://www.gadgetreview.com/2010/11/phosphor-world-time-curved-e-ink-watch-review.html (which links to: http://www.gadgetreview.com/2009/07/phosphor-e-ink-digital-calendar-watch-review.html); or http://www.beautifullife.info/fashion-design/20-unusual-modern-led-watches/ (many being only ‘concept’, i.e. not-in-production imaginings); or the distributor's link at: http://www.phosphorwatches.com/default.asp).

In the prior art the strap paralleled the wrist's flexion line to ensure stability and snug (but not over-tight) compression. This both kept the display centered along and just proximal of the wrist, and placed the display perpendicular to the long axis of the radius and ulna bones in the forearm. The strap, which ran around the forearm and was attached to the casing, ran from the ‘top’ to ‘bottom’ of the casing, but also ran as little as possible over the muscles and tendons of the forearm, in order to avoid cramping or limiting their contractive capabilities.

The essence of good design, good engineering, and (in general) superior goods or performance, is to simplify. It is almost never reached by extending, complicating, or mashing together prior efforts—no matter how successful those may have been! To the contrary, simplification is usually attained by examining assumptions and goals with a mind open to change. New technologies often offer opportunities for re-evaluation which go untaken for years, even decades; but more important than a new technology is that someone re-examines base assumptions from a viewpoint asking ‘what is needed’, instead of starting from and with ‘what has been and is being done’.

To use any sports instrumentation during her activity, an athlete must interact with it; she must control its activation and behavior, and perceive its reading(s). Humans are predominantly visually oriented—particularly while in active motion, since running into things hurts!—and so a visual display is preferable; we can comprehend more quickly far more complexity visually than we can through any other sense. A display is easiest read when it matches our physical orientation—when its horizontal and vertical match our somatic norm (i.e. when its horizontal runs ‘left to right’ and its vertical ‘top to bottom’). We can also translate angular or curving visual offsets, though this takes a bit more effort proportional to the difference between the display's orientation and our somatic norm.

We also can use many parts of our body to activate and govern the motions of controls—we've used everything from our eyes to our toes to manipulate anything from switches to knobs to touchpads to pressure-plates. Yet it is better and again simpler, to use the hand-eye coordination which led us from primate to human intelligence—because we are ‘wired for it’ at deep level.

Inventing a not wrist-centric (thus neither wrist-perpendicular nor wrist-placed) casing and strap for sports instrumentation engaged much more than ‘designer’ or ‘fashion’ or ‘taste’ concerns; it involved identifying, addressing, and solving different locational, functional constraints and pragmatic (meaning external, objective, and reality-based) needs. Designing and making such a casing and strap thus, for the inventors, involved breaking standards and ‘rules’, involved reconsidering basic assumptions, and required both stepping back and away from prior efforts and examining the possibilities offered by newer technologies, so as to obtain functionally-superior performance.

By changing the ‘fit’ of the casing and strap, and the orientation of the display, the inventors made sports instrumentation more usable and less performance-degrading. Whether the display served a timepiece (analog or digital), a GPS locator, a messaging system, any of a medical, environmental condition, or real-time-status sensor, or any other purpose, this invention puts the display where the user can read it most easily (defining that to be, with the least distortion to the user's optimal physical motions in that sport). “Ease of use”, when correctly understood to mean ‘least distorting dynamic’, becomes a functional and effective guide—though only to those who think ‘beyond the simple circle’, as the applicant inventors did.

Putting a display anywhere below the nose yet proximal from an elbow (e.g. upper arm, torso) or knee (upper leg), requires the user to turn or lower her head—thereby changing her balance and distorting her flow of motion. Putting a display on the palm or back of a hand magnifies weight concerns as such a distal placement increases the leverage effect, as well as hazards breakage during normal use, particularly should the hands engage in, as part of the normal practice, any gripping, clenching, slapping, or other contact(s). The inventors thus narrowed their choice of location for any casing and strap to the user's forearm. (Which forearm depends chiefly upon a user's ‘handedness’)

Casing Orientation, Shape & Fit

The larger the display, for any given density of pixilation, the more complete and/or complex information (whether analog or digital), can be shown. However women's wrists—even women athletes' wrists—are as a rule smaller than men's wrists. Moving the display ‘off the wrist’ enabled a larger—and thus more readable—display. It also enabled two immediately-perceptible further advantages. First, that placement lowers the ‘leverage effect’ of the mass for the casing-and-strap. Any given sports instrumentation device could be somewhat more massy than its peers if in a casing-plus-strap that put it further up the forearm and thus less far ‘out’ along the lever-arm than a wrist-centric device. Second, the limiting effects of each and all of the wrist-flexion line, outer tendon-muscle joinders, and wrist-width, for a given athlete, were expanded to more expansible forearm cross-section, forearm muscles, and forearm dimensions.

Most wristwatches have displays and controls which are symmetrical and circular, even if their displays extend further along the horizontal line—that line running parallel to the length of the radius and ulna. In the prior art, even when a display has a skewed orientation, its controls and markings are counter-skewed to keep closer to an overall symmetry (see http://www.heartratemonitor.bz/nike_triax_speed_wr0084_{—}001.asp).

But a display which sought to maximize readability, would preferentially extend one axis over the second for a given planar area, with the choice of axis dependent upon the directionality of the information to be displayed. Text (in Latinate and modern Western languages (and many others, including Cyrillic, Hebraic, and Arabic), or numerals, is more easily read in groups if the width extends further than the height; but ideographic languages (e.g. Kanji) and linear route maps will be more easily read when the height extends further than the width. Regardless of which is preferred, an asymmetry means that the display area will be more rectangular, than square. Locating any control(s) along a further extension of that preferentially-stretched dimension would further increase the asymmetric nature of the casing.

A non-wrist-centric display could be oriented any of three basic ways—parallel to, perpendicular to, or canted at any intermediate angle across, the skeletal understructure (radius and ulna)—as long as the casing-and-strap could establish a secure and stable hold upon the forearm. There is no dominant ‘shortest axis’ as there is with the part of the forearm which is closest adjacent to the wrist.

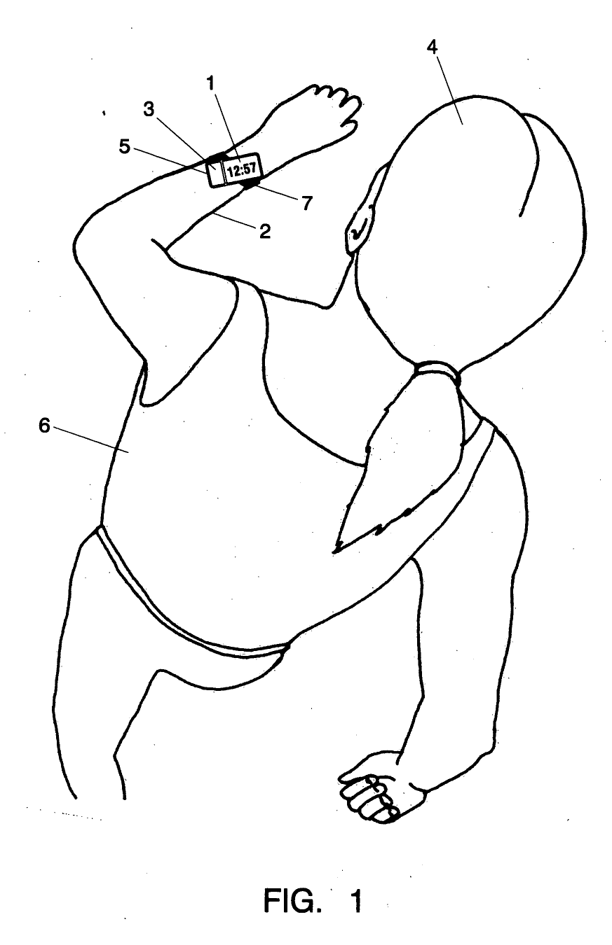

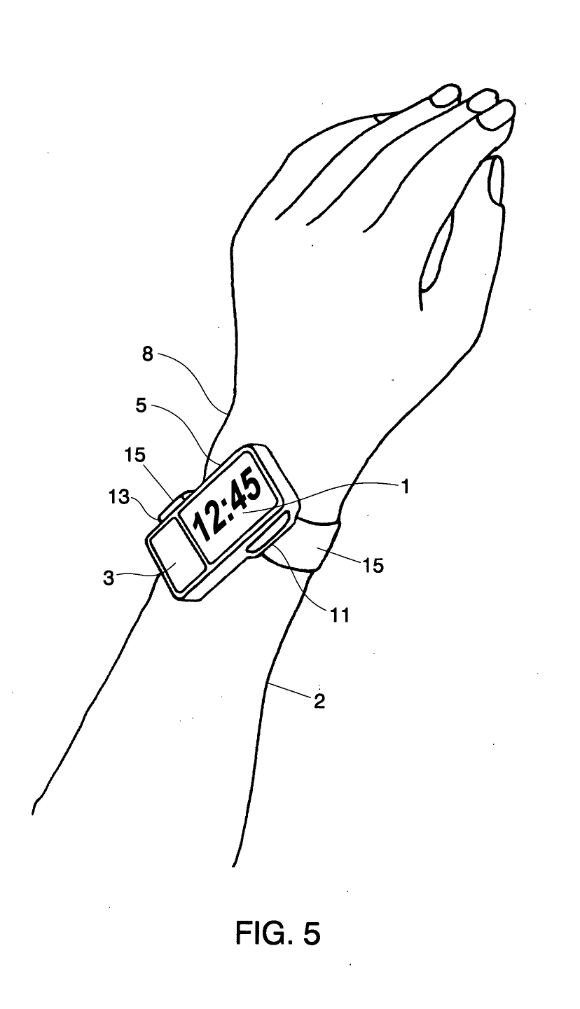

Yasukawa et al. (U.S. Pat. No. 5,735,800; Apr. 7, 1998) did extend one axis; but they teach that it is still necessary for that axis to parallel the long bones of the forearm (see FIG. 1, FIG. 1A, and FIG. 5); as they state, “ . . . but if the device is to be worn on the wrist, it is difficult to greatly increase the size in the six o'clock and twelve o'clock directions. By necessity the device is therefore enlarged in the three o'clock and nine o'clock directions; because enlargement in this direction follows the arm, it is less of a problem.” (Col. 2, lines 14-19). Yasukawa et al. altered the shape of the strap-and-casing from a simple circle to an ellipse. Yet they teach away from the present invention, specifically teaching the answer to how “to provide a wrist-worn portable device . . . even when using a horizontally long device case”. (Col. 2, lines 42-45.)

In the preferred embodiment of the present invention, shown in FIG. 5, the display [1] and a primary control [3] are placed in sequence along the asymmetric and lengthened dimension (or long axis) of the casing [5]. At least one pair of contoured attachment loops [11, 13] are incorporated into the casing [5] with the contoured attachment loops being offset to opposite sides and closest towards opposite ends of the lengthened dimension from each other. At least one strap [15] is passed through and held against a first member of the pair of contoured attachment loops [11], pulled around the forearm [2], passed through and around a second member of the pair of contoured attachment loops [13], and bound to itself (not shown), such that the casing [5] and strap [15] will hold the display [1] and a primary control [3] on and to a diagonal line across the forearm [2] above the flexion line of the wrist [8].

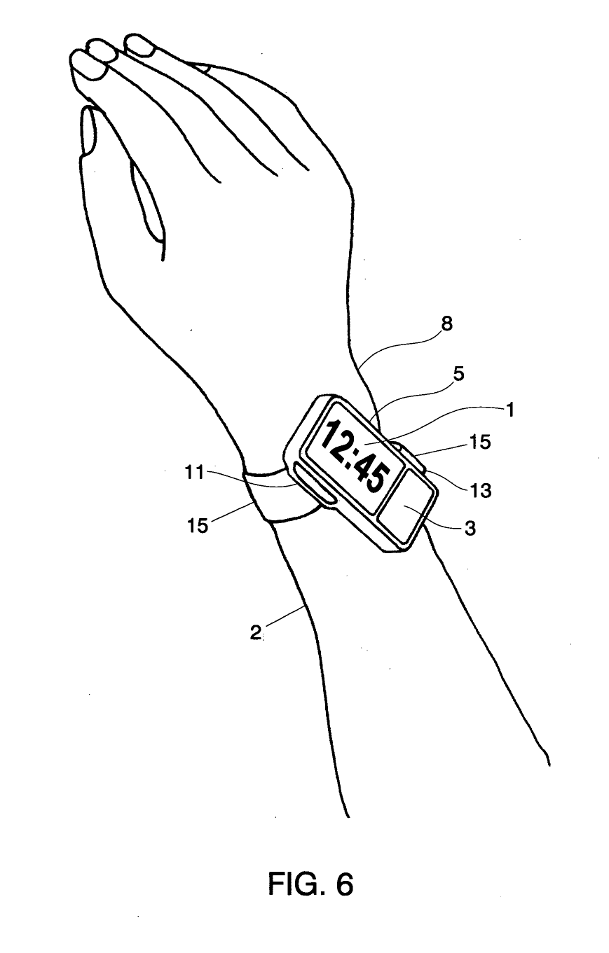

In an alternative embodiment of this invention the first and second members of the pair of contoured attachment loops [11, 13] will be placed towards the reverse ends of the casing's asymmetrical dimension, and the sequential order of the display [1] and a primary control [3] reversed as well, as shown in FIG. 6.

The display [1] (or ‘user display’) not only is angled relative to the prior art ‘circling the wrist’ approach such that it lies both diagonally across the radius and ulna of the user's forearm, but also maximizes a non-circular (rectangular, in the preferred embodiment) display geometry using an asymmetrical extension in the dimension useful for perception of information. While in the preferred embodiment this asymmetrical extension, or longer display axis, is horizontal (looking onto the plane of the display), in the alternative embodiment described in the preceding paragraph this long axis of the display may be ‘vertical’, i.e. paralleling the user's line of view, rather than ‘horizontal’ (perpendicular to the user's line of view).

Or a user may wish to place the wearable display and control on the bottom—palm-side—surface of the forearm, as opposed to the top—back of the hand—side. With reprogrammably-orienting displays a user may wish to switch between these various 90° offsets (right or left forearm, bottom or top surface, horizontal or vertical long axis display orientation), which form a set of mirrored combinations, each of which is claimed. For in each, the casing [5] and strap [15] will hold the display [1] and a primary control [3] placed in sequence along a long axis running diagonally across the user's forearm's surface (FIG. 5 and FIG. 6).

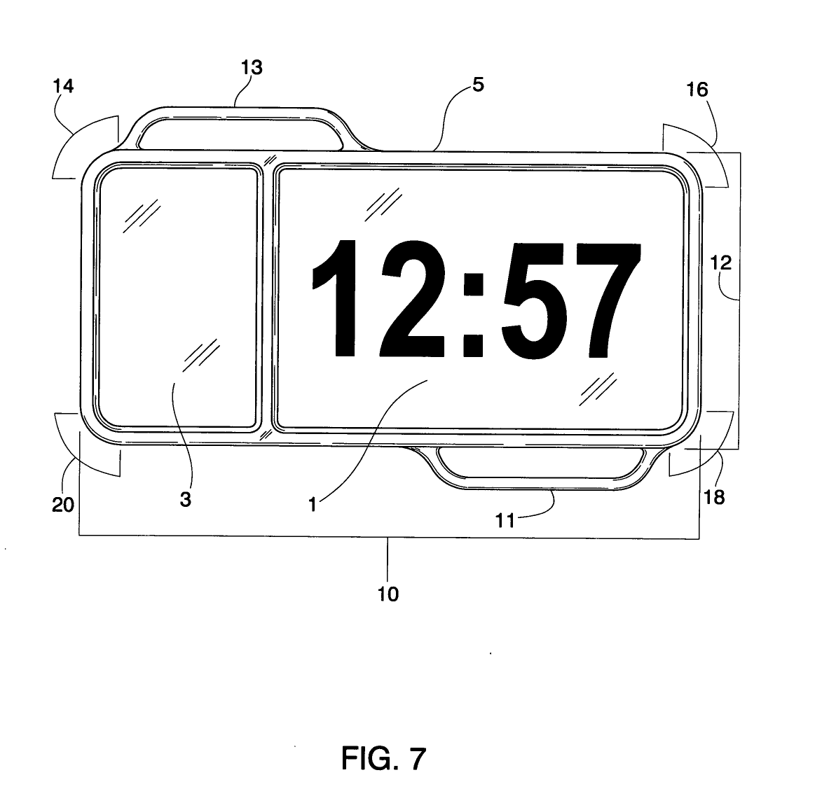

The exterior perimeter of the casing [5], as shown in FIG. 7 in the viewing plane of its display [1], is non-circular, has non-equal, asymmetric linear axes, and forms any of a set of rectangular, rhomboidal, trapezoidal, or elliptical (but not necessarily oval) shapes, further being preferentially separately symmetric across (but not between) each axis (horizontal or vertical) of that viewing plane (in direct contrast to the equilateral square or circular shapes which dominate the prior art).

Deciding to shift from the ‘wrist-centric’ to a diagonal, across-the-forearm, lie, raised a number of new problems. This was not a simple, minor change to the wrist-centric standard approach. Proximally from the wrist the forearm forms an elliptical cone, whose shape changes with the flexion of any, or all, of its muscles. A strap that runs radially ‘around’ the forearm anywhere above the wrist which has any meaningful width, will be more binding at its proximal edge than it will at its distal edge—a binding that will be more keenly felt (and thus discomfortable) as any of the muscles tense. Furthermore, as an athlete can be expected to sweat during exercise, the stability of a given compressive force will decrease over the duration of the exercise, meaning that the device, in its casing-and-strap, will be prone to slip distally (i.e. towards the wrist) if it is only radially secured. There must be tension retaining the whole against a distal vector. Simple, flat-backed (i.e. bottom-surfaced) instruments were not optimal for active users.

A first effort used a band which was co-extensive with the longitudinal length of the casing (J. L. Echelson, U.S. Pat. No. 4,913,326; Apr. 3, 1990; ‘Armband Carrier for Audio Devices’). Echelson avoided the problem of conic diminishment of the forearm entirely, as his device is for the upper arm, not the forearm. Echelson's band and casing are nothing more than a wristband ‘bulked up’, and he specifically taught that his invention was for a different field—that of ‘carriers for portable audio equipment, particularly small radio receivers’ (Col. 1, lines 6-7). Echelson specifically requires that the band be “cylindrical” (Claim 1, Col. 2, line 48; Col. 3, line 4; Claim 2,) and thus teaches away from a strap.

A second effort (S. T. Davies, U.S. Pat. No. 5,205,449; Apr. 27, 1993; ‘A Forearm Gauge and Equipment Holder for Scuba Divers’) used at least a pair of straps situated such that one strap is near each of the longitudinally-separated ends of the casing—with the straps being specified as being both ‘hook and loop fasteners’ and occurring ‘at each mounting pocket (22)” (Col. 3, lines 4-5). Davies’ invention requires that the display's casing's bottom surface have a diminishing conic shape, one with one with a single axis paralleling the length of the forearm around which the bottom surface curves, and one where the left and right sides of the display form a pair of angled, intersecting, straight lines (Davies FIG. 5). He describes this casing thusly: “Contored [sic] interior cavity (52) is a ½ non-linear cone shaped surface with radial dimensions that are proportionate to typical radial dimensions of a human arm.” (Davies, Col. 4, lines 32-35.)

To prevent slip/roll problems Davies incorporates a bottom-surface “hook component of a hook and loop fastener which mates with a loop component of a hook and loop fastener that can be fastened to a divers suit (not shown)” (Col. 3, lines 37-40). Davies, like Echelson, specifically teaches against any device being worn against a user's bare skin. Davies does, however, specifically teaches that the holder should be “sized to extend over a substantial length of a forearm” (Col. 6, lines 1-2) and should be “adapted to conform to a human forearm when placed longitudinally thereon” (Col. 6, lines 2-3). Davies’ invention also required a physiological impossibility; “When secured, the front-end has a smaller interior circumference than the divers wrist . . . ” (Col. 4, lines 7-9)—which places Davies' holder inside the user's wrist, probably causing the user a good deal of pain as a consequence.

A third approach (H. A. P. Barker, GB 2,328,371, publ. Feb. 24, 1999; ‘A forearm-mounted music sheet holder’) like Davies, also used two straps. Barker was moving from the prior art of ‘a wrist strap-mounted holder’ (Page 1, ¶2, last line)—though his invention is for marching musicians, not athletes. He specifies, as did Davies, that each of the pair of straps be located “at or near each end of the elongate plate” (P. 2, last ¶, lines 3-4). Barker also specifically teaches that the straps be permanently attached to the base plate by “being glued to the underside of the plate by suitable adhesive such as a hot melt adhesive” (P. 4, 5^{th}, lines 4-5). Thus Barker also teaches directly away from the current invention where the strap is both intentionally and readily removable and replaceable.

Each of these examples of the prior art incorporated an assumption that the weight—meaning the breadth and thickness of the strap—was unimportant. The fullness of the gripping capacity was deemed more important. But the present inventors recognized that for a given thickness of a wearable display, the more closely the casing-plus-strap melds with the surface of the forearm, the less it presents resistance to air or water during motion. Thus the maximal thickness of attachment between any wearable display and strap is the thickness of the display's casing itself (more would protrude and increase friction). They also recognized that ‘less is more’: less weight and bulk of the strap would interfere less with the user's motion; and make the display, when attached, feel more comfortable, lighter, and easier during use. So a key differentiation from the prior art was the inventor's incorporation of the goal that the strap be thinner, lighter, and less than all-encompassing—even while fully holding to both the wearable display and user's limb. This requires, though, that as much of the strap as possible contribute to the effort of holding the display to the user, thus requiring that the strap attachment to the casing not be a point-failure.

The present invention's inventors also recognized there are different vectors to consider when securing a casing-plus-strap across and around a forearm, as opposed to merely around a wrist, or to an upper arm or all (or a large portion) of a forearm. They recognize that to get a casing to lie flush against the surface of the forearm, its bottom must curve in more than a single plane; it has to curve in three dimensions. Their solution, embodied in the invention, is to match the curvatures of the casing-plus-strap to the forearm's natural curvatures, both in rest and in action. Unlike the prior art found in Yasukawa et al., which has a broad plane of curvature, the present invention requires a narrow plane of curvature. Furthermore, unlike any of the prior art, to retain the position on the forearm of the more efficient wearable display and control for sports instrumentation, the present invention both uses an offset, diagonal strap line and uses the surface of the wearer's skin in part.

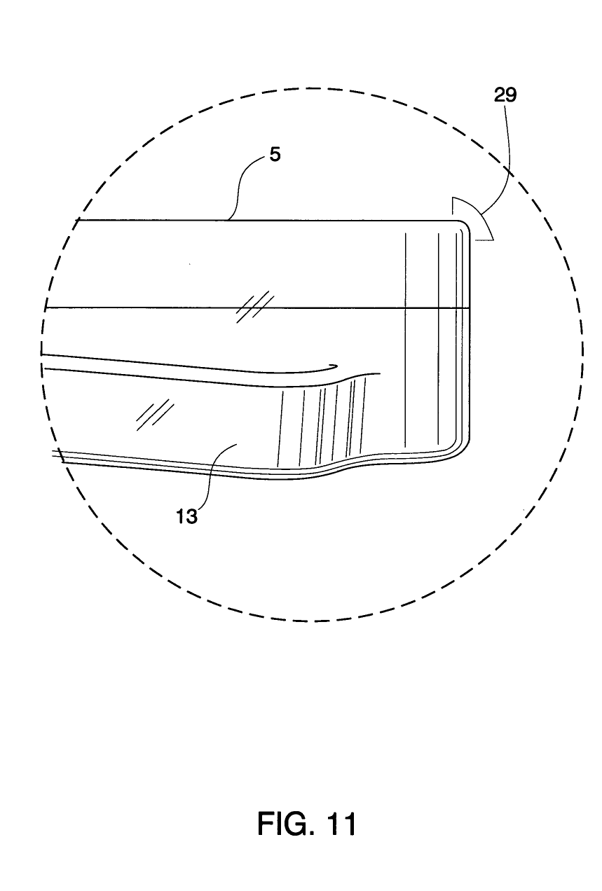

Thus, this shape differs from both the predominantly flat bottom of the prior art and the closest prior art, Anderson (U.S. Pat. No. 7,844,310, Nov. 30, 2010; FIG. 11 [124], [124a], [124b]). Anderson specifically teaches that the bottom surface must be “frustoconically concave” (meaning, the shape of a cone with the tip removed by a plane perpendicular to the long axis of the cone, i.e. parallel to the base of the cone (http://en.wiktionary.org/wiki/frustum; http://www.merriam-webster.com/dictionary/frustoconical). Anderson both specifically teaches that “ . . . the radius of curvature of the back surface decreases along the length L of the housing” (Col. 5, 40-41), and further requires two flat surfaces ([124a] and [124b]) on the outer edges of the back surface (Col. 5, lines 43-46). Anderson emphasizes “because the housing 20 is so much longer than other known wrist-mounted devices (e.g. wristwatches), the cylindrically concave back surface 24 is a discriminating feature” (Col. 4; lines 37-40). Anderson teaches, however, that the “housing 20 is formed in a generally rectangular shape” (Col. 4, lines 8-9) and, most importantly, that the housing parallel the forearm (FIG. 1), not cross the forearm at a diagonal—thus teaching specifically away from the present invention.

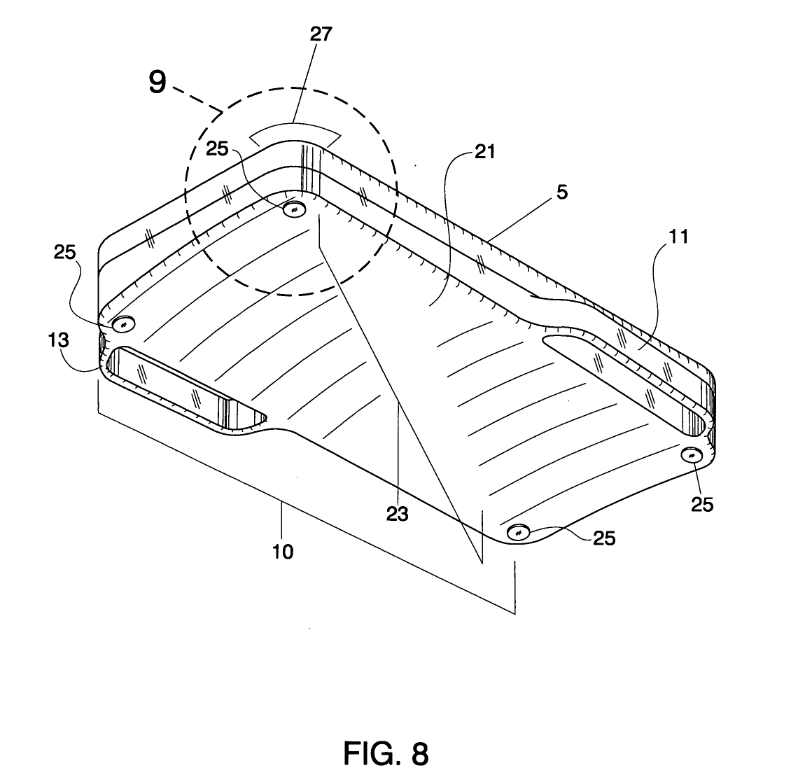

The present invention, however, is specifically shaped so as to place the casing [5] on a diagonal across the user's forearm. FIG. 8 shows the bottom surface [21] of the casing [5]. The bottom surface [21] has an axis of curvature [23] that is diagonal to the long axis of the casing [10]; and this curvature is continued along the bottom surface of each contoured attachment loop [11, 13]. This creates a complex, three-dimensional curvature which matches that of the portion of the forearm (not shown) across which the casing [5] will diagonally lie. The general shape of the bottom surface is concave and angles the top surface to align the long axis of the display across the user's central, forward, view line. (An alternative embodiment aligns the long axis parallel to the user's central, forward, view line.) With the present invention, the diagonal lie across the forearm requires much less material, though a more complex curvature for the bottom surface to hold and keep the casing-and-strap tightly fitted and flush against the forearm. This close fit in turn reduces the cross-sectional presentation of the casing-plus-strap above the surface of the forearm, to the medium through which it moves. For a given thickness, the more closely that a casing-plus strap melds with the surface of the forearm, the less resistance it presents to air or water flowing along the forearm.

Additionally, because the muscles of the forearm where the casing-plus-strap will be placed form a conic surface which has a greater circumference closer to the elbow than it does closer to the wrist, the strap for the casing must cope with this conic diminishment. The inventors realized that this was best done by a strap which also ran diagonally, unlike the current standard, and prior art, where straps are perpendicularly concentric and run radially around the user's forearm without any proximal-to-distal differentiation from side to side of the casing.

In the preferred embodiment, and hereafter in this application, the strap runs diagonally from the outer and proximal casing corner to the inner and distal casing corner; but its reflexive opposite (between the inner proximal and outer distal corners) is also claimed, whether it attaches to a casing oriented diagonally ‘left’ or ‘right’ from a line paralleling the radius and ulna.

Thus unlike the prior art, the present invention includes casing attachments that are offset on a plane, not just a single line. This effects vectors of tension that run the optimal direction for retaining the casing at the selected point of the conic section of the forearm, while incorporating both vertical and horizontal grippage that constrains the casing-plus-strap from sliding down the diminishing conic section of the forearm's musculature.

Lastly, one of the problems faced by all of the prior art—and emphatically so by any invention seeking to keep a device attached during active movement by the user—is the need to constrain ‘slippage’ during and consequentially from the user's active motion. The inventors use a simple fact of human physiology which is ignored in the prior art: the fact that the human skin is ‘dentable’, i.e. that it does not form a rigid surface. In the present invention, as seen in FIG. 8, at each corner of the bottom surface [21] is a convex gripping nub [25] (which is preferably made of a malleable material such as rubber or softer plastic, though it can also be made of any of metal, ceramic, or hard plastic) that protrudes above the generally concave curvature of the bottom surface [21]. Each convex gripping nub [25] will indent the user's skin slightly and thus the entire wearable display for sports instrumentation, with one at each corner, will jointly form a better and more secure ‘hold’ without interfering with the comfort of the user. Thus the bottom surface [21] incorporates both concave and convex curvatures in diametrically-different directions, differentiating it from the prior art where the bottom surfaces have been flat or, at most, convex.

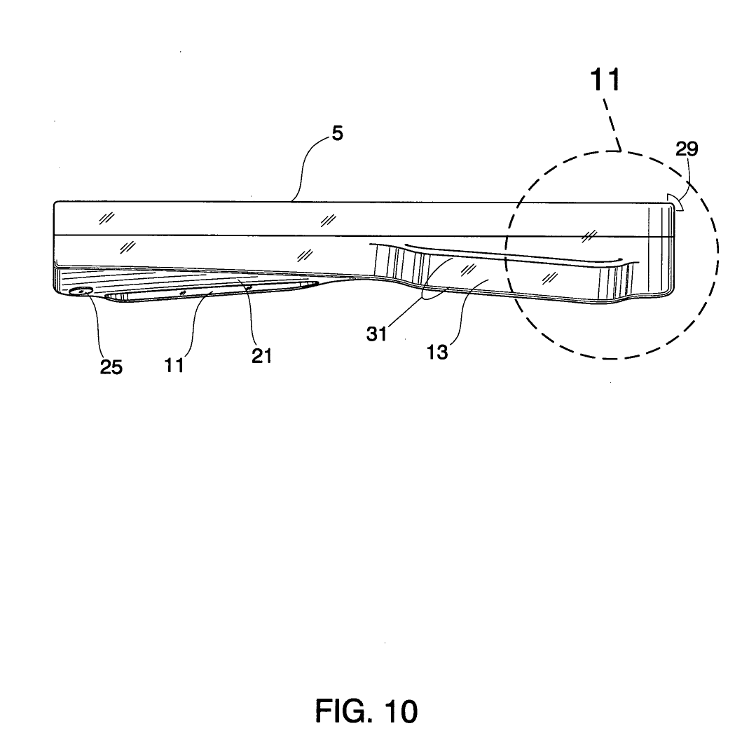

Grippage—or rather slippage—is both a function of the user's motion and of the resistance factor of whatever medium (air or water) the user's forearm is moving through. The higher the casing stands above the surface of the user's skin, the greater the cross-face it presents to resistance. The sequential and asymmetric placement of the display and control (seen in FIG. 7, not shown in FIG. 10) lower the height of the casing [5]. The presence of sharp corners and edges also can create additional drag, as such induce turbulence. With the present invention, not only is the display's casing's bottom surface [21] curved and contoured to fit diagonally across and where it meets the athlete's forearm (the better to hold the casing [5] against the surface of the user's forearm); but also all of the edges and corners [29] of the casing [5] are curved and rounded. These combine to eliminate as much as possible turbulence and resistance from the medium, and thus limit slippage of the wearable display and control.

These elements of the invention have a further effect; because the user is expected to be active and in motion, the casing's rounded edges and corners prevent pressure cuts in any accidental collision (where the casing's edge or corner might be pressed against the user's skin), and its thin and close-fitting lie limit the odds of accidentally knocking it against things. As can be seen in FIG. 10, while the top surface forms a flat plane, the bottom surface [21] has the complex curvature described above—a curvature that continues on and is extended by the contoured attachment loops [11, 13], and which is further complicated by the protruding gripping nubs [25].

Furthermore, the casing could be located on nearly three-quarters of the radial surface of the forearm—any of the forearm's top (same side as the back of the hand), inside (same side as the thumb), or bottom (same side as the palm). Irrespective of this placement, however, the display for the sports instrumentation will be on the upper surface of the casing (the side opposite that adjacent to the skin). But how should the strap holding the casing to the forearm, hold to both casing and forearm?

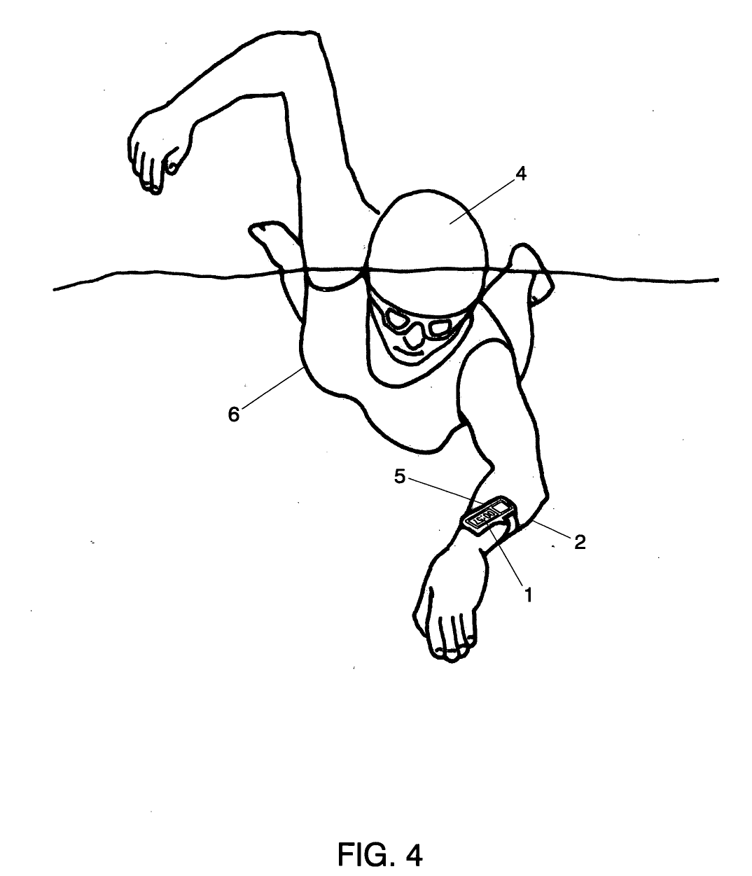

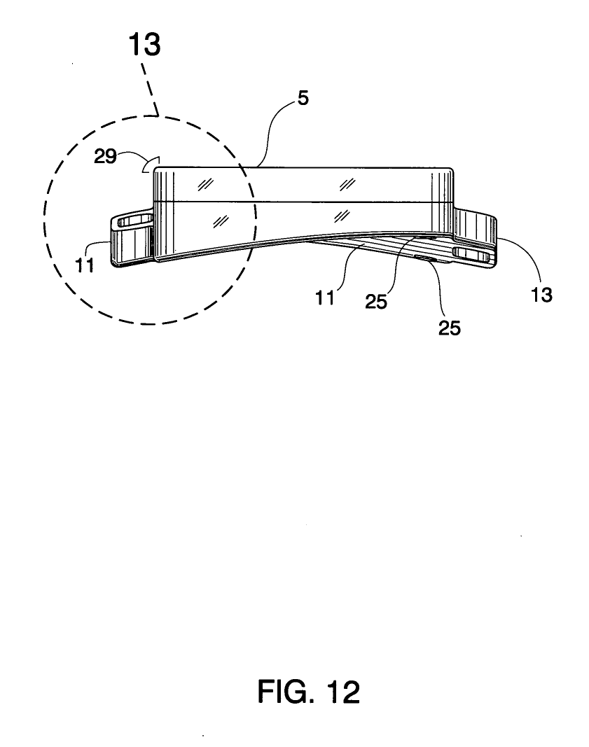

To connect the strap to the wearable display for sports instrumentation, in the prior art the principle—almost universal—means to connect any strap and device, or display, incorporated arms or ‘lugs’ which protruded from a central casing. These lugs extruded parallel to each other and were separated by a distance which preferentially was fractionally wider than the width of the strap, and airs of lugs were linearly offset. The facing side of each pair of lugs incorporated an inset hole. Each end of the strap which was to fit between a pair of lugs (and up against the sidewall of the casing), had a breadth-wise hole drilled into and through it, which hole was then filled with a spring-laden metallic pin, whose respective ends fit into the matching inset holes of the paired lugs. The seminal grand-daddy of the art is Depollier and Duncuff (U.S. Pat. No. 1,194,484), which established all of: (a) lugs (or as they called them, ‘one or more pairs of opposed fingers f’ (Col 2, lines 68-69); (b) pins (‘such bar g’) (Col. 2, line 89), with each of the latter being “a compression bar” (Col. 2, lines 89-90) with extending members and a spring (Col. 2, lines 90-92), and that, (c) “Each outer end of the bar is provided with a projecting pin g⁵ to enter a corresponding recess f³ formed in the inner face of the corresponding finger f, as clearly shown in FIG. 4.” (Col. 2, lines 94-98.) FIG. 12 shows this standard attachment, along with the most-common-denominator of a buckle-and-holes fastener which joins the separate halves of the strap together around the wrist.

That this standard approach created at least one problem was recognized at least half-a-century ago. Sand (U.S. Pat. No. 2,870,511; Jan. 27, 1959) stated:
“At the present time wrist watch bands are secured to the projecting lugs on a wrist watch by means of a spring bar connector. The connector customarily employed comprises a cylindrical tube within which is mounted a pair of pins that are spring urged outwardly. This type of connector or spring bar has found almost universal acceptance in the field. In positioning the spring bar, it is first inserted through the loop in the end of the watch band or strap. One projecting pin is thereupon inserted in the hole or opening in the lug or projecting portion of the watch case. To insert the other pin in position it is necessary to first retract the pin into its tubular housing. This is customarily done by pushing the end of the pin until it is retracted sufficiently to insert the spring bar in its proper position. The retracted pin then releases to secure the spring bar in position. The operation of inserting the spring bar in position between the lugs or projecting portions of the watch case is a tedious one and is often quite difficult because of the shape and contour of the watch case. In addition the projecting pins are conventionally quite small and difficult to retract.” (Col. 1, lines 19-40)
   (Sand then went on to patent a even-more-finely machined and more complex spring with a flat housing and sliding finger control.)

Of course watchmakers would not be at all fazed by, nor rarely concerned about, whether improvements required more small, fine, and preferably metal parts, or needed fine tools (and even finer vision and hand-eye coordination) to assemble together. Those were the elements of the watchmaker's specialized trade! Problems such as weakening the points of connection and thus attachment of a wearable display and strap to each other were not considered critical by the vast majority; for originally, watches were too delicate, expensive, and above all assumed to be worn by those socially-respectable, to be used in any hard, or active, effort. By the time the cheap, even disposable watches (“Swatch”) came along, the mass-production aspect of lugs-and-pin connections outmuscled any interest in paying for reconsideration of engineers' assumptions.

Among the problems this ‘lug and pins’ approach created are: (a) the connection is only as strong as the weakest point, which could be any of the pin, pin-end, housing, or strap where the pin drilled through it; (b) users needed tools to install or replace a strap-and-pins, which were too fine for average manual dexterity; and, (c) the complexity—and consequent cost—of parts and assembly of the strap-plus-pins-plus-housing, drive up the costs of manufacture. All of these together make straps readily and easily replaced by consumers, nearly inconceivable.

The present invention, through simplification, eliminates or reduces to a minimum each and all of these concerns. Firstly, both lugs and pins are eliminated—rather, they are replaced by being joined into a single aspect of the wearable display's casing. Where the prior art would use a pair of lugs between which a double-ended, spring-loaded pin would be inserted, the present invention uses a single, continuous, contoured attachment loop [11, 13], each of which is an extension from and connected with the side of the display's casing [5]. These contoured attachment loops [11, 13] are paired, symmetric, and offset to opposite sides, and opposite ends, of the long axis of the display. In the preferred embodiment the offset is such that if a first line were drawn along the long axis of the display and a second line were drawn between the respective centers of the contoured attachment loops [11, 13], the acute angle formed at the intersection of the first and second lines would be between 35° and 60°. In topological terms the display's casing [5] with a single pair of contoured attachment loops [11, 13], belongs to the two-hole homotopy class.

Each said continuous, contoured attachment loop [11, 13] further has rounded (rather than sharply edged) exterior edges and corners, and its profile is no higher, and in the preferred embodiment lower, than the height, thus the top surface, of the casing [5]. Each contoured attachment loop's lower surface forms a matching extension of the curvature of the bottom surface [21] of the casing [5] so the bottom surface of the casing melds smoothly and continuously into the bottom surface of the contoured attachment loop. The thickness of each continuous, contoured attachment loop [11, 13] is uniform for most of its outer portion, which widens to effect a curved blending with the surface of the casing [5] which forms the inner side of the attachment loop (see FIG. 5, FIG. 11.)

In the preferred embodiment the height of each continuous, contoured attachment loop [11, 13], for the entirety of its length is no less than half of the corresponding height of the side of the casing [5] measured at the central and flattest medial point, even though the top point for all of the continuous, contoured attachment loop's upper surface will be below the top point of the casing at every point along its length as the attachment loop conforms to and follows the curving contour of the casing's bottom surface [11, 13]; see FIG. 10 [13]).

The advantage of such continuous, contoured attachment loop [11, 13] is that all of its thickness serves to hold the strap [15] to the casing [5]. There is no ‘reduced’ weak point, as with any lugs-and-pins approach in the prior art.

Also, connecting the strap [9] to the casing [3] requires neither fine tools nor a watchmaker's trained manual dexterity, as is detailed in the referenced co-pending patent application.

Finally, there is also a significant reduction in the complexity of manufacturing for any strap as the number of separate, and finely-machined parts is reduced (indeed, virtually eliminated); the strap has no pins, pins with tubes, deflection plates, c-shaped or interior banding cross-windings, or any other intricacies of the prior art approaches to the joining of straps, pins, and lugs.

Because the separate ends of the strap [15] run between the diagonally-offset (from the display's orientation) pair of continuous, contoured attachment loops [11, 13], the line of the strap [15] between the continuous, contoured attachment loops [11, 13] and line of the casing's [5] long axis cross between 35° and 60° as described above; and, when the strap [15] is connected to the pair of continuous, contoured attachment loops [11, 13] and tightened, this creates a planar and not just linear tension, thereby binding both casing [5] and strap [15]—and thus the wearable display for sports instrumentation more securely to the forearm [2].

Power Supply

The display [1] and primary control [3] will require energy to operate, so the invention comprises a power supply to serve them to be contained within the casing [5]. However, this power supply need only be capable of meeting the far lower demands of the display [1] and primary control [5], not the demands and drain of the sports instrumentation itself, and thus can be satisfied with a standard type of ‘coin cell’ watch battery with like duration (year+, as opposed to hours, days, or weeks), without requiring frequent recharging. Furthermore, since the power capacity of any type of battery is still directly proportional to its weight, and the majority of the power demand for sports instrumentation is the sensing/recording elements thereof, both of these can be separately located on the user's body in a location closer to the user's center of mass—creating, thereby, much less trouble and requiring much less effort during performance.

Wireless Communications Link(s)

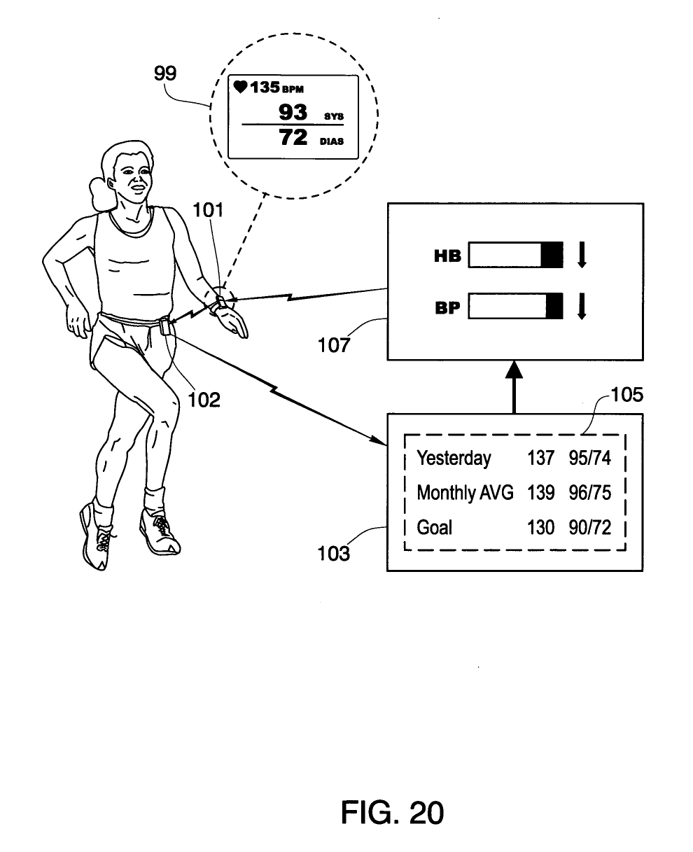

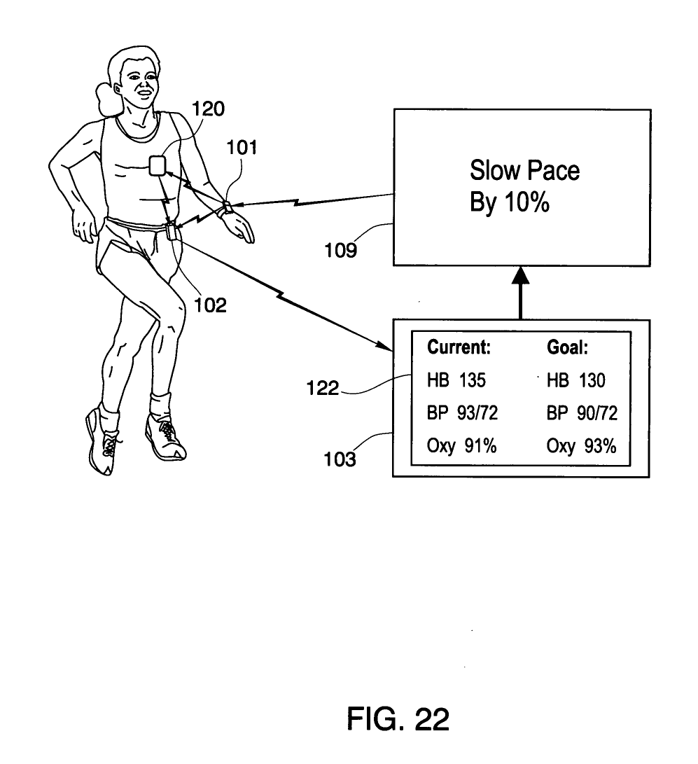

In a further embodiment the invention further comprises a short-range (one-two meter) wireless communications link (not shown) capable of connecting the wearable display and control to any set of at least one sports instrumentation device, an intermediate-range wireless communications link, a long-range (meters-miles) wireless communication link (FIG. 20, [102]), additional, supporting, or secondary instrumentation devices (FIG. 22, [120]), or a third-party wearable display and control. This short-range wireless communication link can function whether any other member of said set of other devices is worn or carried at the user's forearm [2], or on the athlete's body closer to her center of mass, or is communicating with the wearable display and control from an externally-sourced location(s).

In the preferred embodiment the invention comprises within the casing [5] a short-range (one-two meter) wireless communication link (not shown) that connects the wearable display and control worn or carried at her forearm with a separate, long-distance wireless communications link [120], which long-distance wireless communications link is independently housed or incorporated into the sports instrumentation; and these wireless linkages may use any of a set of transmitting or receiving or transceiving signals to connect through, to, and with any set of additional, supporting, or secondary instrumentation device(s) or computational resources, including members of this set specifically not carried on her body.

The prior art has disclosed the use of accelerometers to determine ‘phat air’ or ‘loft time’ for extreme sports such as snowboarding or ski jumping, or somewhat less extreme but vehicle-using sports such as mountain biking. Many patents have been issued to Vock, Flentov, et al. in the field which they first described as:
“the measurement of the loft time and speed of a vehicle relative to the ground. Such measurements are particularly useful in sporting activities like skiing and mountain biking where users desire information relating to their speed and/or loft, or “air” time.” (U.S. Pat. No. 5,636,146; Flentov et al.; Jun. 3, 1997; “Apparatus and Methods for Determining Loft Time and Speed”; Col. 1: 5-10; compare to the phrasing in U.S. Pat. No. 6,856,934, Vock et al., Feb. 15, 2005, “Sport Monitoring Systems and Associated Methods”: “the detection and display of loft, or “air” time and/or speed of vehicles such as sporting vehicles, including skis, bikes and snowboards” (Col. 2; lines 9-11)
   As applicants neither require a vehicle nor make any claim to measure ‘loft time and speed’, these patents are only marginally relevant and do not anticipate the specific details of the location, means of attachment, and particulars of the display and controls, described in the present application.

For example, in U.S. Pat. No. 6,825,777 (Vock, et al., “Sensor and Event System, and Associated Methods”, issued Nov. 30, 2004), that system incorporates in its summary “‘n’ sensors, ‘m’ repeaters, a base station, and an operations terminal”, plus “One or more sensors [which] attach to each athlete (and/or the athlete's vehicle . . . .” (Col. 1; lines 25-27). None of these elements is required by the present invention. At most, these prior inventions show that the use of a wireless connection between a sensor and one or more external devices has been anticipated by the prior art. (See also Vock et al., U.S. Pat. No. 6,959,259, “System and Methods for Determining Performance Data”, Oct. 25, 2005, Claim 1, Col. 62, lines 6-9).

However, in U.S. Pat. No. 6,825,777, as in others, Vock, Flentov et al. explicitly teach away from the applicants' invention. In this patent (and others), they use a boundary or limiting time, generally “that is greater than approximately five seconds” (Col. 3, lines 62-64), in order to exclude from any measurement period those times when a skier is not “aloft”. Moreover, Vock, Flentov, et al. merely mention in their applications that data may be “transmitted to the person for easy viewing on the watch” (Col. 6; lines 10-11); yet they also teach that the GPS sensor, transmitter, and microprocessor are all contained within the same housing (Claim 1, Col. 29, line 67-Col. 30, line 8).

Elsewhere, in U.S. Pat. No. 7,092,846, Aug. 15, 2006, Vock et al., “Systems and Methods for Determining Performance Data”, they teach the use of a “monolithic protective housing for attachment to the moving person” (Claim 1, Col. 61, lines 62-63) or “a GPS sensor configured with the watch” (in Claim 9) which also incorporates “a microprocessor . . . for processing the signals to determine the performance data for display at the watch”. (Claim 9, Col. 62, lines 30-34.)

In several of their patents Vock, et al. require that the sensors be located in a shoe or garment (U.S. Pat. No. 8,217,788, Jul. 10, 2012; U.S. Pat. No. 7,983,876, Jul. 19, 2011; U.S. Pat. No. 7,911,339, Mar. 22, 2011; U.S. Pat. No. 7,623,987, Nov. 24, 2009; U.S. Pat. No. 7,457,724, Nov. 25, 2008; U.S. Pat. No. 7,171,331, Jan. 30, 2007); or else require and incorporate a digital camera (U.S. Pat. No. 7,739,076, Jun. 15, 2010; U.S. Pat. No. 6,813,586, Nov. 2, 2004); or a vehicle (Flentov et al.; U.S. Pat. No. 5,960,380, Sep. 28, 1999). As applicants require none of shoe, garment, or vehicle, and use two-stage and differentiated (short- and long-range) wireless links, these inventions by Vock, et al. teach away from and do not anticipate the present application.

Control; Modes; Zero Mode

A user display is of limited use without a means for the user to control both whether, and how, the information meant to be conveyed through the display is shown. Accordingly the present embodiment of the invention includes at least at least one primary control [3] for the user display, with said primary control governing whether, and how, the information meant to be conveyed through the display is shown. Said display [1] starts in a ‘zero mode’; with the primary control [3] providing a modal state change for the display, with a minimal initial set of default/active/emergency modes. The mode activated depends upon the combination of the existing state and the absence, existence of, and duration of, activation of the primary control [3].

The default initial mode when power is supplied to the wearable display and control, its ‘zero mode’ (also known as the standby display), shows the current reading from the primary sports instrumentation. In the preferred embodiment, this is a watch, so the default initial mode is to show the current time.

Active Mode

In the preferred embodiment of the present invention two separate modal states (each differing from the zero mode) can be activated when from the zero mode respectively by (1) a short single press on the primary control [3]; and (2) an extended press lasting at least five seconds on the primary control [3].

Reversion to Zero Mode

In the preferred embodiment of the present invention, reversion to the zero mode occurs in the absence of any additional control activation for that length of time set for that currently-active mode.

Displays of Current Sports Instrumentation Reading

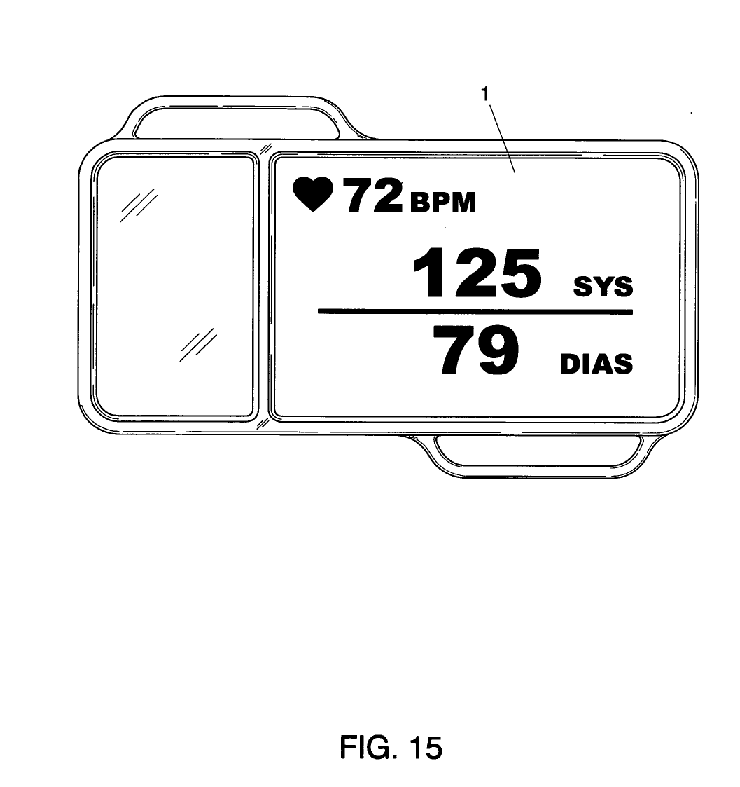

FIG. 15 shows an example of an active mode reachable by a single short press on the primary control [3] from the zero mode; namely, the current heartbeat and blood pressure readings from a pulsimeter are shown on the display [1].

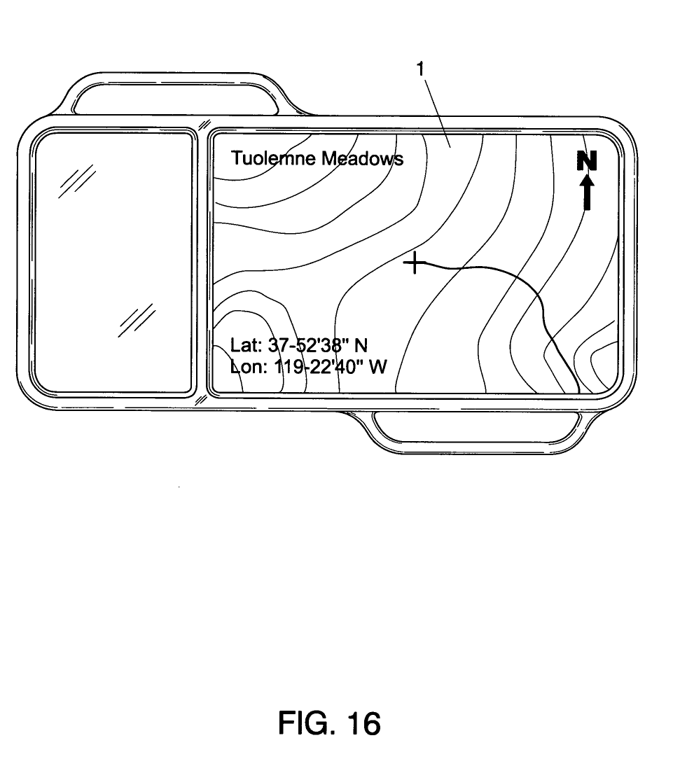

FIG. 16 shows an example of an active mode reachable by a single short press on the primary control [3] from the zero mode, through the wireless links (short and long-range [102]); namely, the current location and recent track of the user on a topographic map are shown on the display [1].

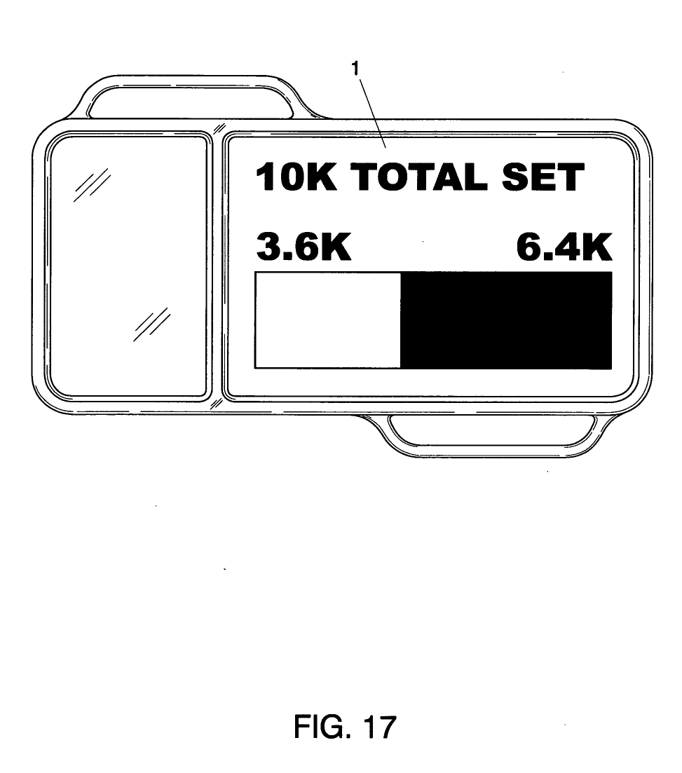

FIG. 17 shows an example of an alternative active mode reachable by a single short press on the primary control [3] from the zero mode, when the sports instrumentation is a pedometer; namely, the current total distance covered, and the total goal distance set, is shown on the display [1].

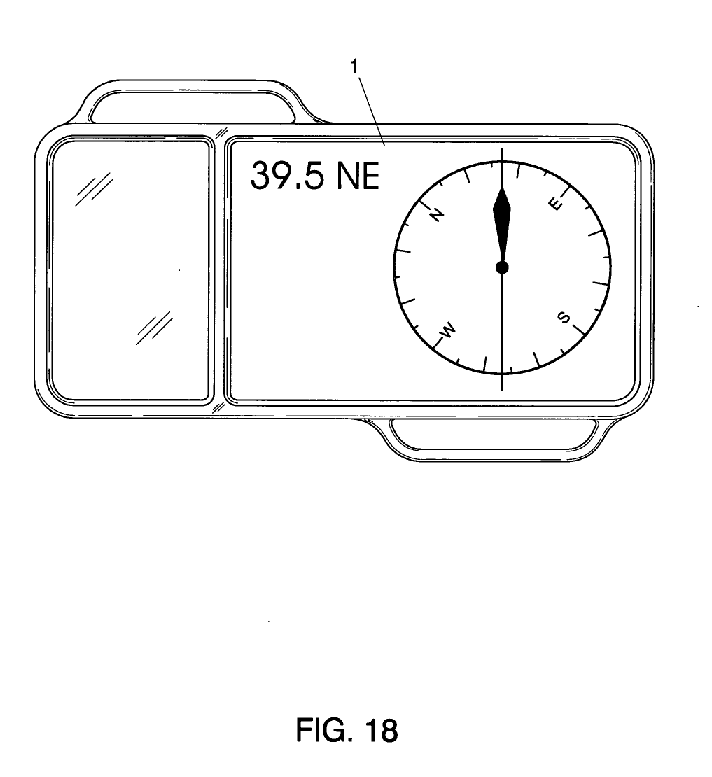

FIG. 18 shows an example of an alternative active mode reachable by a single short press on the primary control [3] from the zero mode when the sports instrumentation is a compass; showing on the display, the current orientation of the user to magnetic North.

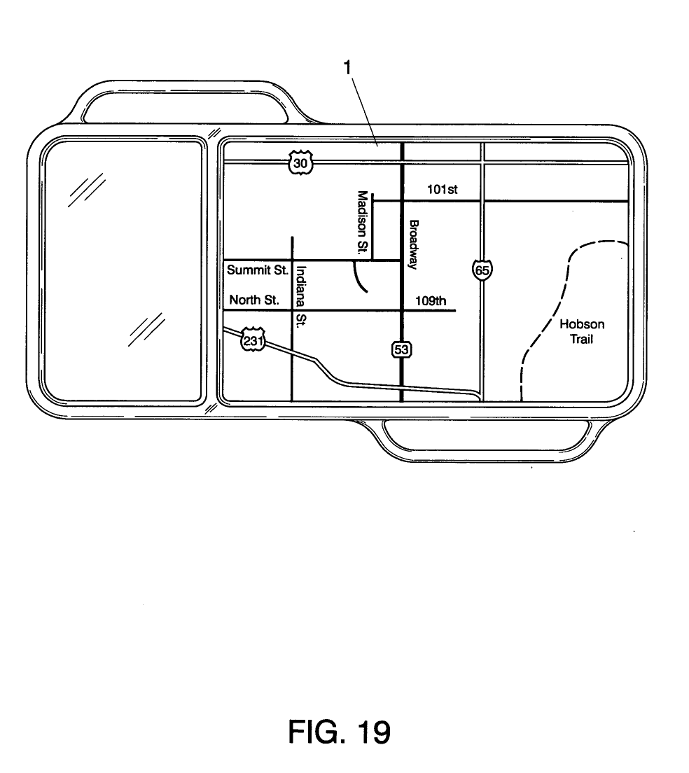

FIG. 19 shows an alternative active mode reachable by a single short press on the primary control [3] from the zero mode, through the wireless links (short and long-range [102]); namely, the current map centered around the user's location showing roads and trails, is shown on the display [1].

(Inter)-Active Display Mode

If from the zero mode, the user makes a short single press on the primary control [3], this activates an ‘activity-specific interaction mode’ (or ‘Interactive Display Mode’) for the wearable display and control. In the activity-specific interaction mode the display [1] becomes governed by touch-screen hardware, or controls (not shown) now activated on and in the display [1], which in this embodiment is a touch-screen with enabling hardware and embedded software, i.e. with touch-screen control hardware for specific functional-change control for the sports instrumentation enabling further differentiation and fine control thereof in accordance with the pattern(s) established by the user. The configuration of both the now-interactive display and touch-screen control activations and responses are managed through signals sent by the wireless link (not shown) to the long-range wireless link [102] to an external computational resource [103]. This external computational resource [103] may be housed with any of the sports instrumentation or ‘cloud’ computing devices to which the wearable display and control is connected to through the wireless links, short and long range, at that time.

This activity-specific interaction mode comprises at least one visual display element, using the touch-screen and activated software to provide specific functional and operational control for a variety of interactions, using differentiation of physical contact between the user's body (presumably finger(s)) and touch screen, to select the function from the range of possibilities provided from the external computational resource [103], with the display [1] being responsive to and reactive with the operation of such controls, so that any software or embedded firmware within either the external computational resource [103] or sports instrumentation [120] receives control signals within the set they are designed to effect, and the display [1] displays the responses resulting from such control signals. These together form responsive display means for any instrument-function specific, programmable, touch-activated, control software for the athlete's use of the sports instrumentation, and its interaction with the wearable display and control.

The user, prior to activating the primary control [3] and entering the activity-specific interaction mode, must enter into the external computational resource [103] the patterns of controls and responses they wish the display [1] and touch-screen to show, interact with and respond to. This could be done over the user's smartphone, computer, or through purchase of a pre-set package from an ‘app store’ or other third-party provider of a prepared response package.

The interactive pattern of display and touch-screen control is conveyed through the wireless link [102] to the display [1], detailing what is to be displayed and what touch-screen control functions can be responded to. This may depend, further, on the specific sports instrumentation (hardware and software) engaged.

For example, a user may choose to activate a package for a ‘swim event’; so the activity-specific interaction mode will either automatically enter the ‘swim event’ pattern (if that is the only pattern and choice available), or include that on a list of possible patterns, which is then entered by the user tapping on that line indicating ‘swim event’. Once entered (or selected and then entered), the ‘swim event’ may display pace measurements (“minutes/100 meters”) appropriate to that selected activity. For another example, a user may choose to activate a package for ‘triathlon’, which will indicate a list (typically ‘swimming; cycling; running’) for each of the segments of the activity. The user then will tap that segment currently engaged in (e.g. ‘cycling’) and the display will then show, according to a further sub-choice by corner, ‘time’, ‘distance covered/remaining’, ‘current speed’, ‘average speed’.

Default Activity Mode; Timer Only

In the preferred embodiment if a user enters the activity-specific interaction mode and has not otherwise established a separate pattern, or choice of patterns, for interaction, the display will engage a watch with a timer, lap timer, and lap counter, as differentiable selections via touch-screen selection, to be displayed.

Comparative Readings Mode

In a further embodiment of the present invention an additional modal state, a comparative readings mode, can be activated by a patterned use of single, extended, or single and extended presses within a short window of time; this activates a comparative readings mode where the current reading(s) from the sports instrumentation(s) are displayed along with a set of comparative readings communicated through the wireless links (short and long-range [102]) from the remote computation and record-keeping system [103], according to the selection from a menu (not shown) of the sensor readings desired, representing any of the set of past performances, future goals, or necessary minimum scalars to qualify for a pre-specified level of capability the user determined; in this example as seen in FIG. 20, a graphical ‘thermometer gauge’ readout [99] indicating both how close the current readings are to the goals and which direction of change is desired (the downward arrow) is shown on the display [1].

Performance Update Mode

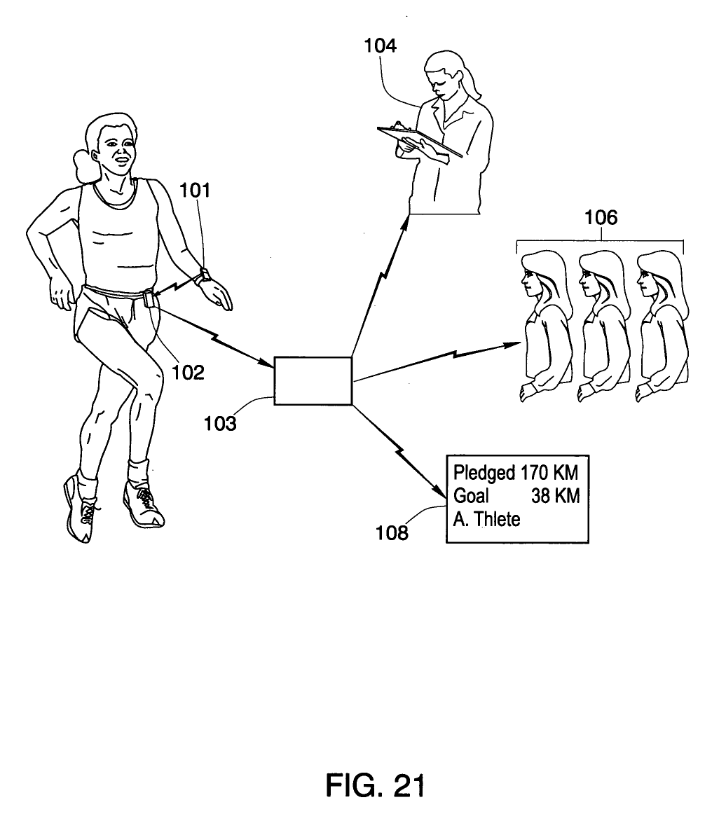

In another further embodiment of the present invention an additional modal state, a performance update mode, can be activated by a patterned use of single, extended, or single and extended presses within a short window of time; this activates a performance update mode where the current reading(s) from the sports instrumentation(s) are communicated through the wireless links (short and long-range [102]) from the remote computation and record-keeping system [103], to the end recipients desired and selected from a menu (not shown) for their feedback (including perhaps supporting analysis, encouragement, or commentary) to the athlete; as shown in FIG. 21 this performance update mode links the user with any of the set of other individuals such as a coach or health professional [104], a group of supporters or friends [106], informing them as to the user's current performance relative to a goal or pledge [108].

In another alternative further embodiment of the present invention this performance update mode, as shown in FIG. 22, can reflect feedback [109] to the user indicating how to alter their performance to best attain a desired goal, based upon the current reading(s) from a specific sports instrumentation sensor [120].

Emergency Mode

If, from the zero mode, the user activates the primary control [3] with an extended press lasting at least five seconds (i.e. an extended continuous press), then an emergency mode is entered. In the preferred embodiment of this invention entering ‘emergency mode’ triggers the pre-programmed response, which in the default would be sending through the wireless links (short and long [102] an emergency alert signal which causes the remote computation and record-keeping system [103] to initiate a ‘911’ call for emergency response to the user at her current location.

Configurable Alert

In a yet further embodiment of this invention, if the user activates the emergency mode (by pressing the primary control [3] for more than 5 seconds continuously), then the wireless links (short and long [102] transmit an emergency alert signal to the remote computation and record-keeping system [103] which the user can pre-configure to any set of triggerable responses, which may include any or all of: (a) initiating a ‘911’ call for emergency response; (b) displaying a warning to the athlete to stop her overly-stressful level of activity [FIG. Z, 911H]; (c) alerting a third-party emergency-response or security service (e.g. ‘Life Alert®’, ‘Alert1®’, ADT, Pinkertons, etc.); (d) transmitting the device's (and presumably the user's) current location; (e) sending a text message to one or more specific individuals to alert them to the user's emergency; (f) initiating a location-tracking and comparison recording effort at a remote location which will regularly and repeatedly query and record the user's location to determine whether she is remaining in the same place or being moved, perhaps against her will.

A user may establish a list of individuals, her personal condition(s), and possible emergencies (including third-party, family-related calls for immediate help) that may be met while she is exercising, which will be triggered into coordinated action (a first friend from the list picking up the athlete from the nearest drivable point and a second friend taking the athlete's child to a hospital after the child's monitor recorded an asthma attack) on the part of the athlete and others.

The details of the specific responses to the automatic emergency alarm mode being entered depend not upon the emergency alert signal, but upon the user-configurable pattern which the user placed in the receiving instrument.

Emergency Overload Limit Passed

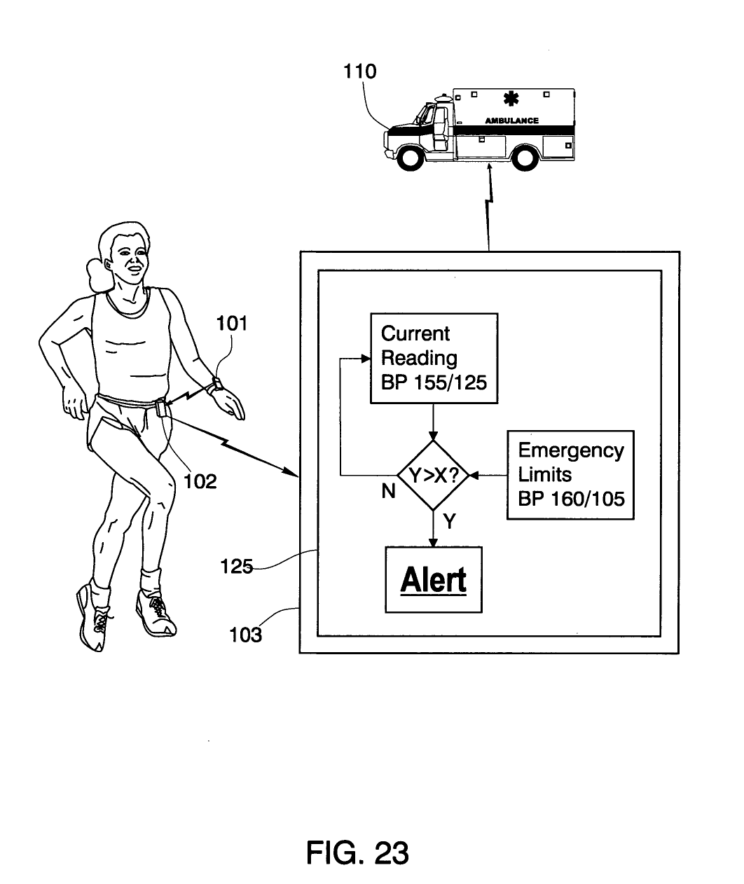

In a still further embodiment of this invention as shown in FIG. 23, if the sports instrumentation detects and sends through the wireless communication links (short and long [102]) to the remote computation and record-keeping system [103] a reading which exceeds a predetermined ‘safety limit’ [125], this triggers a signal activating the emergency alarm response appropriate to the triggering signal. In this way, if a blood pressure reading exceeds a safe limit (high, for a stroke; low, for passing out) (FIG. 23; [125]), or any of the (not-shown) alternatives such as, a pulse reading exceeding a safe limit (too fast, indicating possible fibrillation; too low, indicating imminent failure); or an extreme accelerometer or ‘G-force’ reading (whether too high, indicating a crash or impact sufficient to cause serious injury; or too low, indicating no motion has been sensed over a predetermined duration, suggesting that the user is no longer moving and thus may be unconscious, paralyzed, held, or otherwise immobilized); then the wearable display and control enter the emergency alarm mode, triggering transmission of the emergency alert signal. In such event it is also possible for both detected reading and limit, as the cause for the alert, to also be transmitted after and along with the emergency alert signal.

Loss-of-Signal as Emergency Alert

One alternative trigger for an emergency mode would be a loss of signal from the wearable display and control, which would initiate a call to emergency personnel to the last reported location with the time of loss-of-signal also being given. If the athlete was involved in any sort of accident that damaged her unit, the probability that she escaped harm would be extremely low; but, more importantly, if any hostile person were to abduct the athlete, by disabling the unit she could signal the need for intervention in a way least likely to be suspected by the kidnappers; for, however vigilant they might be to detect a cry for help, they could never know that the absence of any signal of continued safety, was already serving as the most damning cry for aid.

Alert Continues Until Disabled

Another alternative emergency mode would continuing of the emergency signal until disabled through positive action by the user. In the preferred embodiment this requires, after the emergency mode has been entered and a subsequent delay, a second and equal-length (>5 seconds) continuous press, to turn off the emergency mode and cancel the triggered alert.

Other data, alone or in any combination, form a set of alert conditions that could be incorporated as pre-set triggers; these could include, for example, weather reports, particularly of extreme, or dangerous, weather conditions; or for hikers, skiers, and travelers in the backcountry generally, warnings of environmental transients ranging from tornadoes to lightning strikes, wildfires, or terrain-created inclement weather (mountain storms, desert sandstorms). The user could receive and have shown on her display [1] a textual, or visual, message indicating local adverse conditions which may cause her to change her intentions and further activities for safety-related reasons.

Embedded Memory and Computation

In a further embodiment the casing will incorporate, in addition to the display and control, additional computational resources and memory (both operational and stable storage), and embedded software and/or firmware, enabling operation of the display and primary and touch-screen control. In yet a further embodiment of the invention, this computational resources, memory, and embedded software and/or firmware will enable also the computation, analysis, and comparison of the information from the sports instrumentation and an external source for information relevant to the function and interest of the athlete, and the presentation on the display of the results thereof.

Additional Sports Instrumentation(s) and Users

In further embodiments of the invention the wearable display and control will further comprise a connection which joins with not just a single sports instrumentation, but any positive number and combination of supporting packages from the following set: those measuring a condition of the external environment (compass, thermometer, barometer, radiation, Ground Positioning System (“GPS”), presence or absence or absence or level of a particular organic or inorganic chemical substance(s) or molecule(s)); those measuring a condition of the athlete (her internal environment, so her blood pressure(s), blood glucose level, temperature, pulse, presence or absence or level of a particular organic or inorganic chemical(s) or molecule(s)); and those sensing and reporting particular radio signal(s); those measuring the effect of the athlete's activity (pedometer, accelerometer(s); or those communicating with at least one, externally-located, second and similar but separate device worn or carried by a different user.

This data to be transmitted or received could be, for example, any of the athlete's performance-related efforts (stride and/or stroke counts for running, swimming, or climbing; lap history), internal condition (a physiological reading e.g. heartbeat, blood pressure, blood oxygenation level, blood sugar level), the athlete's external circumstance (such as the athlete's present location determined through a Global Positioning System (GPS) element.

In a further embodiment of the invention the wearable display and control will further comprise a connection which joins with both the original, or ‘main’, sports instrumentation, and also at least one secondary, additional instrumentation for a combined functional display, including but not limited to a user-centric and local map of the terrain with locational and time-lapse progress records.

In a further embodiment of the invention the wearable display and control will further comprise a connection which joins both the original or ‘main’ sports instrumentation which is located in the casing, and also at least a member of a set of secondary, additional sports instrumentation or other supporting packages that is carried or worn at a more body-centric location and which provides any non-zero subset of additional power, functionality, computational capacity, or memory.

It would be possible, for example, for this external further analytical effort to computer the athlete's caloric consumption, whether as a current rate or total-in-session, by comparing multiple inputs both internal and external such as the athlete's pulse rates during the exercise, current elapsed time, stride pace, distance covered, altitude, barometric, and thermometer readings, without having to either carry all of the prior data or wait for the athlete to personally return to her computer for her data to be synchronized.

If the user has the extensional GPS element they can select an activity (e.g. running, swimming) and instruct the system to use the GPS-extended-unit to track their course over time; individual datapoints of location-and-time will be recorded to the external computational and data device and the resulting course and pace sent back to and displayed on the unit's display. Comparative readings (whether previous performance(s) or pre-set goal(s)) can also be retrieved from the external computational and data device and displayed on the unit's display to encourage the athlete during each run/swim/session.

A third extensional embodiment is to combine the data from more than one wearable display and control worn on any set of more than one user (each worn on a single user) for such external recordation, analysis, computation, and interaction. A set of users could coordinate their efforts such that each carried a different external-environmental sensor (temperature, barometer, particulate count, gas composition meter); or they could carry duplicate sensors to assure consistency and validity for the environmental condition readings; or each could share her or his personal condition (heart rate) to effect a group's more consistent yet non-over demanding pace.

While this invention has been described in reference to illustrative embodiments, this description is not to be construed in a limiting sense. Various modifications and combinations of the illustrative embodiments as well as other embodiments of the invention will be apparent to those skilled in the art upon referencing this disclosure. It is therefore intended this disclosure encompass any such modifications or embodiments.

The scope of this invention includes any combination of the elements from the different embodiments disclosed in this specification, and is not limited to the specifics of the preferred embodiment or any of the alternative embodiments mentioned above. Individual user configurations and embodiments of this invention may contain all, or less than all, of the elements disclosed in the specification according to the needs and desires of that user. The claims stated herein should be read as including those elements which are not necessary to the invention yet are in the prior art and are necessary to the overall function of that particular claim, and should be read as including, to the maximum extent permissible by law, known functional equivalents to the elements disclosed in the specification, even though those functional equivalents are not exhaustively detailed herein.

Although the present invention has been described chiefly in terms of the presently preferred embodiment, it is to be understood that the disclosure is not to be interpreted as limiting. Various alterations and modifications will no doubt become apparent to those skilled in the art after having read the above disclosure. Such modifications may involve other features which are already known in the design, manufacture and use of timepieces, GPS units, or medical instrumentation and which may be used instead of or in addition to features already described herein. The physical elements herein are not limiting but instructive of the embodiment of the invention, and variations which are readily derived through alternatives, substitutions, or transformations which are standard or known to the appropriate art are not excluded by omission. Accordingly, it is intended that the appended claims are interpreted as covering all alterations and modifications as fall within the true spirit and scope of the invention in light of the prior art.

Additionally, although claims have been formulated in this application to particular combinations of elements, it should be understood that the scope of the disclosure of the present application also includes any single novel element or any novel combination of elements disclosed herein, either explicitly or implicitly, whether or not it relates to the same invention as presently claimed in any claim and whether or not it mitigates any or all of the same technical problems as does the present invention. The applicants hereby give notice that new claims may be formulated to such features and/or combinations of such features during the prosecution of the present application or of any further application derived therefrom.

We claim:

1. A wearable display and control for sports instrumentation for an athlete, comprising:
a casing to hold the display and the control for at least one sports instrumentation, said casing further comprising:
asymmetric long and short axes respectively forming its sides and ends;
a top surface;
a sequential orientation of display and a primary control;
rounded and curved edges and corners;
a bottom surface that is contoured to fit diagonally across a forearm of the athlete;
at least a pair of contoured attachment loops, said pair being offset to opposite sides and closest towards opposite ends of the casing;
at least one display;
at least one primary control for the sports instrumentation, said primary control providing modal state change for the display;
a power source contained within the casing and capable of meeting the demands of the display and control; and,
a short-range wireless communications link, capable of connecting the wearable display and control to any of a set of: at least one sports instrumentation device;
an intermediate-range wireless communications link; a long-range communications link; additional, supporting, or secondary instrumentation devices; a remote computation and record-keeping system; and a third-party's wearable display and control.

2. A wearable display and control for sports instrumentation for an athlete as in claim 1, wherein the bottom surface angles the top surface to align the long axis parallel to the user's central, forward, view line.

3. A wearable display and control for sports instrumentation for an athlete as in claim 2, wherein the bottom surface further comprises:
a three-dimensional and generally concave curvature which matches that of the portion of the forearm across which the casing will diagonally lie and an axis of that three-dimensional curvature that is diagonal to the long axis of the casing.

4. A wearable display and control for sports instrumentation for an athlete as in claim 3, wherein the three-dimensional and generally concave curvature of the bottom surface further angles the top surface to align the long axis across the user's central, forward, view line.

5. A wearable display and control for sports instrumentation for an athlete as in claim 3 wherein the bottom surface further has at each corner a convex gripping nub that protrudes from the generally concave curvature.

6. A wearable display and control for sports instrumentation for an athlete as in claim 1, wherein each contoured attachment loop further comprises:
rounded exterior edges and corners;
a lower surface that forms a matching extension of the curvature of the bottom surface of the casing, so the bottom surface of the casing melds smoothly and continuously into the bottom surface of the contoured attachment loop;
a thickness that is uniform for most of its outer portion, which widens to effect a curved blending with the surface of the casing which forms the inner side of the contoured attachment loop; and,
a profile lower than the height of the casing.

7. A wearable display and primary control for sports instrumentation for an athlete as in claim 1, wherein the primary control provides a modal state change, further comprising:
a minimal initial modal set of zero/active/emergency modes;
activation from the zero mode state to the active mode state by a short single press on the primary control;
activation from the zero mode state to the emergency mode state by an extended press lasting at least five seconds on the primary control; and,
reversion to the zero mode in the absence of any additional control activation for that length of time set for that currently-active mode;
wherein change of mode depends upon the combination of the existing state and the absence, existence of, and duration of, activation of the primary control.

8. A wearable display and control for sports instrumentation for an athlete as in claim 7, wherein the display further comprises:
at least one visual display element;
touch-screen control hardware for specific functional-change control for the sports instrumentation governed by human touch upon the visual display element; and,
responsive display means for any instrument-function specific, programmable, touch-activated, control software for the athlete's use of the sports instrumentation.

9. A wearable display and primary control for sports instrumentation for an athlete as in claim 8, further comprising
an activity-specific interaction mode governed by the touch-screen control hardware;
specific functional and operational control for a variety of interactions, using differentiation of physical contact between the user's body and touch-screen hardware; and,
with the display being responsive to and reactive with specific functional and operational control;
in accordance with the pattern of controls and responses the athlete wishes the display and control to show, interact with and respond to.

10. A wearable display and control for sports instrumentation for an athlete with an activity-specific interaction mode as in claim 9, further comprising a comparative readings mode wherein at least one current reading from the sports instrumentation is displayed along with a set of comparative readings communicated through the wireless link according to the selection from a menu of the readings desired, representing any of the set of past performances, future goals, or necessary minimum scalars to qualify for a pre-specified level of capability the user determined.

11. A wearable display and control for sports instrumentation for an athlete with an activity-specific interaction mode as in claim 9, further comprising a performance update mode where at least one current reading from the sports instrumentation is communicated through the wireless link to the end recipients desired and selected from a menu for their feedback to the athlete

12. A wearable display and control for sports instrumentation for an athlete with an activity-specific interaction mode as in claim 11, further comprising a performance update mode with the feedback indicating to the athlete how to alter her performance to best attain a desired goal, based upon the current reading from at least one specific sports instrumentation.

13. A wearable display and control for sports instrumentation for an athlete with an emergency mode as in claim 7, further comprising, in response to the activation from the zero mode state by an extended press lasting at least five seconds on the primary control, of transmission of an emergency alert signal to a remote computation and record-keeping system which the user can pre-configure to any set of triggerable responses, which may include any or all of:
(a) initiating a ‘911’ call for emergency response;
(b) displaying a warning to the athlete to stop her overly-stressful level of activity;
(c) alerting a third-party emergency-response or security service;
(d) transmitting the device's current location;
(e) sending a text message to one or more specific individuals to alert them to the user's emergency; and,
(f) initiating a location-tracking and comparison recording effort at a remote location which will regularly and repeatedly query and record the user's location to determine whether she is remaining in the same place or being moved, perhaps against her will.

14. A wearable display and primary control for sports instrumentation for an athlete as in claim 1, wherein an emergency mode can be activated not through the primary control, but if the sports instrumentation detects a reading which exceeds a predetermined safety limit, which activation triggers a signal activating the emergency alarm response appropriate to the triggering signal.

15. A wearable display and control for sports instrumentation with an emergency mode activated, as in claim 14, not through the primary control, but in the loss of signal from the wearable display and control.

16. A wearable display and control for sports instrumentation as in claim 1, further comprising computational resources and memory (both operational and stable storage), and embedded software and/or firmware, enabling operation of the display and primary control.

17. A wearable display and control for sports instrumentation for an athlete, comprising:
a casing to hold the display and the control for at least one sports instrumentation, said casing further comprising:
asymmetric long and short axes respectively forming its sides and ends;
a top surface;
a sequential orientation of display and a primary control;
rounded and curved edges and corners;
a bottom surface that:
is contoured to fit diagonally across a forearm of the athlete, having both a three-dimensional and generally concave curvature which matches that of the portion of the forearm across which the casing will diagonally lie and an axis of that three-dimensional curvature that is diagonal to the long axis of the casing;
angles the top surface to align the long axis across the user's central, forward, view line; and,
has at each corner a convex gripping nub that protrudes from the generally concave curvature;
at least a pair of contoured attachment loops, said pair being offset to opposite sides and closest towards opposite ends of the casing, with each contoured attachment loop further having:
rounded exterior edges and corners;
a lower surface that forms a matching extension of the curvature of the bottom surface of the casing, so the bottom surface of the casing melds smoothly and continuously into the bottom surface of the contoured attachment loop;
a thickness that is uniform for most of its outer portion, which widens to effect a curved blending with the surface of the casing which forms the inner side of the contoured attachment loop; and,
a profile lower than the height of the casing;
at least one user display, said user display further comprising:
at least one visual display element;
touch-screen control hardware for specific functional-change control for the sports instrumentation; and,
responsive display means for any instrument-function specific, programmable, touch-activated, control software for the athlete's use of the sports instrumentation;
at least one primary control for the sports instrumentation, said primary control providing modal state change for the display;
a power source contained within the casing and capable of meeting the demands of the display and control; and,
a short-range wireless communications link, capable of connecting the wearable display and control to any of a set of: at least one sports instrumentation device;
an intermediate-range wireless communications link; a long-range communications link; additional, supporting, or secondary instrumentation devices; a remote computation and record-keeping system; and a third-party's wearable display and control.

18. A wearable display and control for sports instrumentation for an athlete, comprising:
a casing holding at the top surface of the casing and in sequence along the horizontal plane of the casing, the display and control, and further comprising:
where the exterior perimeter of the casing in the viewing plane of the display is any of the following set of shapes: non-circular, formed with non-equal, asymmetric linear axes, rectangular, rhomboidal, trapezoidal, and elliptical;
an external shape that is separately symmetric across but not between each axis, horizontal or vertical, of that viewing plane;
rounded and curved edges and corners;
a bottom surface that:
is contoured to fit diagonally across a forearm of the athlete, having both a three-dimensional and generally concave curvature which matches that of the portion of the forearm across which the casing will diagonally lie and an axis of that three-dimensional curvature that is diagonal to the long axis of the casing;
angles the top surface to align the long axis across the user's central, forward, view line; and,
has at each corner a convex gripping nub that protrudes from the generally concave curvature;
at least a pair of contoured attachment loops, said pair being offset to opposite sides and closest towards opposite ends of the casing, with each contoured attachment loop further having:
rounded exterior edges and corners;
a lower surface that forms a matching extension of the curvature of the bottom surface of the casing, so the bottom surface of the casing melds smoothly and continuously into the bottom surface of the contoured attachment loop;
a thickness that is uniform for most of its outer portion, which widens to effect a curved blending with the surface of the casing which forms the inner side of the contoured attachment loop; and,
a profile lower than the height of the casing;
at least one user display, said user display further comprising:
at least one visual display element;
touch-screen control hardware for specific functional-change control for the sports instrumentation; and,
responsive display means for any instrument-function specific, programmable, touch-activated, control software for the athlete's use of the sports instrumentation;
at least one primary control for the sports instrumentation, said primary control providing modal state change for the display;
a power source contained within the casing and capable of meeting the demands of the display and control; and,
a short-range wireless communications link, capable of connecting the wearable display and control to any of a set of: at least one sports instrumentation device;
an intermediate-range wireless communications link; a long-range communications link; additional, supporting, or secondary instrumentation devices; a remote computation and record-keeping system; and a third-party's wearable display and control.

19. A wearable display and control for sports instrumentation for an athlete as in claim 18, wherein the casing further comprises a flat top surface.

20. A wearable display and control for sports instrumentation for an athlete as in claim 18, where in the casing further comprises a concave top surface.
